(19) United States
(12) Patent Application Publication
(10) Pub. No.: US 2008/0297614 A1
(43) Pub. Date: Dec. 4, 2008

(54) Optical Apparatus for Virtual Interface Projection and Sensing

(76) Inventors: Klony Lieberman, Jerusalem (IL); Yuval Sharon, Kochav Hashahar (IL); Yachin Yarchi, Jerusalem (IL)

Correspondence Address: LADAS & PARRY LLP, 26 WEST 61ST STREET, NEW YORK, NY, 10023, US

(21) Appl. No.: 10/543,293

(22) PCT Filed: Oct. 31, 2004
(86) PCT No.: PCT/IL04/00995

§ 371 Date: May 30, 2007

Related U.S. Application Data
(60) Provisional application No. 60/515,647, filed on Oct. 31, 2003.
(60) Provisional application No. 60/532,581, filed on Dec. 29, 2003.
(60) Provisional application No. 60/575,702, filed on Jun. 1, 2004.
(60) Provisional application No. 60/591,606, filed on Jul. 28, 2004.
(60) Provisional application No. 60/598,486, filed on Aug. 3, 2004.

(51) Int. Cl. H04N 5/235; H04N 9/12

(52) U.S. Cl. 348/222.1; 348/744; 348/E05.034

(57) ABSTRACT

Optical and mechanical apparatus and methods for improved virtual interface projection and detection, by combining this function with still or video imaging functions. The apparatus comprises optics for imaging multiple imaged fields onto a single electronic imaging sensor. One of these imaged fields can be an infra red data entry sensing functionality, and the other can be any one or more of still picture imaging, video imaging or close-up photography. The apparatus is sufficiently compact to be installable within a cellular telephone or personal digital assistant. Opto-mechanical arrangements are provided for capturing these different fields of view from different directions. Methods and apparatus are provided for efficient projection of image templates using diffractive optical elements. Methods and apparatus are provided for using diffractive optical elements to provide efficient scanning methods, in one or two dimensions.

### REFERENCE TO RELATED APPLICATIONS

The present application is related to and claims priority from the following U.S. Provisional Patent Applications, the disclosures of which are hereby incorporated by reference: Applications No. 60/515,647, 60/532,581, 60/575,702, 60/591,606 and 60/598,486.

### FIELD OF THE INVENTION

The present invention relates to optical and mechanical apparatus and methods for improved virtual interface projection and detection.

### BACKGROUND OF THE INVENTION

The following patent documents, and the references cited therein are believed to represent the current state of the art:

PCT Application PCT/IL01/00480, published as International Publication No. WO 2001/093182,
PCT Application PCT/IL01/01082, published as International Publication No. WO 2002/054169, and
PCT Application PCT/IL03/00538, published as International Publication No. WO 2004/003656,

the disclosures of all of which are incorporated herein by reference, each in its entirety.

### SUMMARY OF THE INVENTION

The present application seeks to provide optical and mechanical apparatus and methods for improved virtual interface projection and detection. There is thus provided in accordance with a preferred embodiment of the present invention, an electronic camera comprising an electronic imaging sensor providing outputs representing imaged fields, a first imaging functionality employing the electronic imaging sensor for data entry responsive to user hand activity in a first imaged field, at least a second imaging functionality employing the electronic imaging sensor for taking at least a second picture of a scene in a second imaged field, optics associating the first and the at least second imaging functionalities with the electronic imaging sensor, and a user-operated imaging functionality selection switch operative to enable a user to select operation in one of the first and the at least second imaging functionalities. The above described electronic camera also preferably comprises a projected virtual keyboard on which the user hand activity is operative.

The optics associating the first and the at least second imaging functionalities with the electronic imaging sensor preferably, includes at least one optical element which is selectably positioned upstream of the sensor only for use of the at least second imaging functionality. Alternatively and preferably, this optics does not include an optical element having optical power which is selectably positioned upstream of the sensor for use of the first imaging functionality.

In accordance with another preferred embodiment of the present invention, in the above described electronic camera, the optics associating the first and second imaging functionalities with the electronic imaging sensor includes a beam splitter which defines separate optical paths for the first and the second imaging functionalities. In any of the above-described embodiments, the user-operated imaging functionality selection switch is preferably operative to select operation in one of the first and the at least second imaging functionalities by suitable positioning of at least one shutter to block at least one of the imaging functionalities. Furthermore, the first and second imaging functionalities preferably define separate optical paths, which can extend in different directions, or can have different fields of view.

In accordance with yet another preferred embodiment of the present invention, in those above-described embodiments utilizing a wavelength dependent splitter, the splitter is operative to separates visible and IR spectra for use by the first and second imaging functionalities respectively.

Furthermore, any of the above-described electronic cameras may preferably also comprise a liquid crystal display on which the output representing an imaged field is displayed. Additionally, the optics associating the first imaging functionality with the electronic imaging sensor may preferably comprise a field expander lens.

There is further provided in accordance with yet another preferred embodiment of the present invention, an electronic camera comprising an electronic imaging sensor providing outputs representing imaged fields, a first imaging functionality employing the electronic imaging sensor for taking a picture of a scene in a first imaged field, at least a second imaging functionality employing the electronic imaging sensor for taking a picture of a scene in at least a second imaged field, optics associating the first and the at least second imaging functionalities with the electronic imaging sensor, and a user-operated imaging functionality selection switch operative to enable a user to select operation in one of the first and the at least second imaging functionalities.

The optics associating the first and the at least second imaging functionalities with the electronic imaging sensor preferably, includes at least one optical element which is selectably positioned upstream of the sensor only for use of the at least second imaging functionality. Alternatively and preferably, this optics does not include an optical element having optical power which is selectably positioned upstream of the sensor for use of the first imaging functionality.

In accordance with another preferred embodiment of the present invention, in the above described electronic camera, the optics associating the first and second imaging functionalities with the electronic imaging sensor includes a wavelength dependent splitter which defines separate optical paths for the first and the second imaging functionalities. In any of the above-described embodiments, the user-operated imaging functionality selection switch is preferably operative to select operation in one of the first and the at least second imaging functionalities by suitable positioning of at least one shutter to block at least one of the imaging functionalities. Furthermore, the first and second imaging functionalities preferably define separate optical paths, which can extend in different directions, or can have different fields of view.

Furthermore, any of the above-described electronic cameras may preferably also comprise a liquid crystal display on which the output representing an imaged field is displayed. Additionally, the optics associating the first imaging functionality with the electronic imaging sensor may preferably comprise a field expander lens.

In accordance with still more preferred embodiments of the present invention, the above mentioned optics associating the first and the at least second imaging functionalities with the electronic imaging sensor may preferably be fixed. Additionally and preferably, the first and the second imaged fields may each undergo a single reflection before being imaged on the electronic imaging sensor. In such a case, the reflection of the second imaged field may preferably be executed by means of a pivoted stowable mirror. Alternatively and preferably, the first imaged field may be imaged directly on the electronic imaging sensor, and the second imaged field may undergo two reflections before being imaged on the electronic imaging sensor. In such a case, the second of the two reflections may preferably be executed by means of a pivoted stowable mirror. Furthermore, the second imaged field may be imaged directly on the electronic imaging sensor, and the first imaged field may undergo two reflections before being imaged on the electronic imaging sensor.

There is further provided in accordance with still another preferred embodiment of the present invention, an electronic camera as described above, and wherein the first imaging functionality is performed over a spectral band in the infra red region, and the second imaging functionality is performed over a spectral band in the visible region, the camera also comprising filter sets, one filter set for each of the first and second imaging functionalities. In such a case, the filter sets preferably comprise a filter set for the first imaging functionality comprising at least one filter transmissive in the visible region and in the spectral band in the infra red region, and at least one filter transmissive in the infra red region to below the spectral band in the infra red region and not transmissive in the visible region, and a filter set for the second imaging functionality comprising at least one filter transmissive in the visible region up to below the spectral band in the infra red region. In the latter case, the first and the second imaging functionalities are preferably directed along a common optical path, and the first and the second filter sets are interchanged in accordance with the imaging functionality selected.

In accordance with a further preferred embodiment of the present invention, there is also provided an electronic camera as described above, and wherein the user-operated imaging functionality selection is preferably performed either by rotating the electronic imaging sensor in front of the optics associating the first and the at least second imaging functionalities with the electronic imaging sensor, or alternatively by rotating a mirror in front of the electronic imaging sensor in order to associate the first and the at least second imaging functionalities with the electronic imaging sensor.

There is also provided in accordance with yet a further preferred embodiment of the present invention, an electronic camera as described above, and also comprising a partially transmitting beam splitter to combine the first and the second imaging fields, and wherein both of the imaging fields are reflected once by the partially transmitting beam splitter, and one of the imaging fields is also transmitted after reflection from a full reflector through the partially transmitting beam splitter. The partially transmitting beam splitter may also preferably be dichroic. In either of these two cases, the full reflector may preferably also have optical power.

There is even further provided in accordance with another preferred embodiment of the present invention, a portable telephone comprising telephone functionality, an electronic imaging sensor providing outputs representing imaged fields, a first imaging functionality employing the electronic imaging sensor for data entry responsive to user hand activity in a first imaged field, at least a second imaging functionality employing the electronic imaging sensor for taking at least a second picture of a scene in a second imaged field, optics associating the first and the at least second imaging functionalities with the electronic imaging sensor, and a user-operated imaging functionality selection switch operative to enable a user to select operation in one of the first and the at least second imaging functionalities.

Furthermore, in accordance with yet another preferred embodiment of the present invention, there is also provided a digital personal assistant comprising at least one personal digital assistant functionality, an electronic imaging sensor providing outputs representing imaged fields, a first imaging functionality employing the electronic imaging sensor for data entry responsive to user hand activity in a first imaged field, at least a second imaging functionality employing the electronic imaging sensor for taking at least a second picture of a scene in a second imaged field, optics associating the first and the at least second imaging functionalities with the electronic imaging sensor, and a user-operated imaging functionality selection switch operative to enable a user to select operation in one of the first and the at least second imaging functionalities.

In accordance with still another preferred embodiment of the present invention, there is provided a remote control device comprising remote control functionality, an electronic imaging sensor providing outputs representing imaged fields, a first imaging functionality employing the electronic imaging sensor for data entry responsive to user hand activity in a first imaged field, at least a second imaging functionality employing the electronic imaging sensor for taking at least a second picture of a scene in a second imaged field, optics associating the first and the at least second imaging functionalities with the electronic imaging sensor, and a user-operated imaging functionality selection switch operative to enable a user to select operation in one of the first and the at least second imaging functionalities.

There is also provided in accordance with yet a further preferred embodiment of the present invention optical apparatus for producing an image including portions located at a large diffraction angle comprising a diode laser light source providing an output light beam, a collimator operative to collimate the output light beam and to define a collimated light beam directed parallel to a collimator axis, a diffractive optical element constructed to define an image and being impinged upon by the collimated light beam from the collimator and producing a multiplicity of diffracted beams which define the image and which are directed within a range of angles relative to the collimator axis, and a focusing lens downstream of the diffractive optical element and being operative to focus the multiplicity of light beams to points at locations remote from the diffractive optical element. In such apparatus, the large diffraction angle is defined as being generally such that the image has unacceptable aberrations when the focusing lens downstream of the diffractive optical element is absent. Preferably, it is defined as being at least 30 degrees from the collimator axis.

There is even further provided in accordance with a preferred embodiment of the present invention optical apparatus for producing an image including portions located at a large diffraction angle from an axis comprising a diode laser light source providing an output light beam, a beam modifying element receiving the output light beam and providing a modified output light beam, a collimator operative to define a collimated light beam, and a diffractive optical element constructed to define an image and being impinged upon by the collimated light beam from the collimator, and producing a multiplicity of diffracted beams which define the image and which are directed within a range of angles relative to the axis. The large diffraction angle is generally defined to be such that the image has unacceptable aberrations when the focusing lens downstream of the diffractive optical element is absent. Preferably, it is defined as being at least 30 degrees from the collimator axis. Any of the optical apparatus described in this paragraph, preferably may also comprise a focusing lens downstream of the diffractive optical element and being operative to focus the multiplicity of light beams to points at locations remote from the diffractive optical element.

Furthermore, in accordance with yet another preferred embodiment of the present invention, there is provided optical apparatus comprising a diode laser light source providing an output light beam, and a non-periodic diffractive optical element constructed to define an image template and being impinged upon by the output light beam and producing a multiplicity of diffracted beams which define the image template. The image template is preferably such as to enable data entry into a data entry device.

There is also provided in accordance with a further preferred embodiment of the present invention, optical apparatus for projecting an image comprising a diode laser light source providing an illuminating light beam, a lenslet array defining a plurality of focussing elements, each defining an output light beam, and a diffractive optical elements comprising a plurality of diffractive optical sub-elements, each sub-element being associated with one of the plurality of output light beams, and constructed to define part of an image and being impinged upon by one of the output light beam from one of the focussing elements to produce a multiplicity of diffracted beams which taken together define the image. The image preferably comprises a template to enable data entry into a data entry device.

In accordance with yet another preferred embodiment of the present invention, there is provided optical apparatus for projecting an image, comprising an array of diode laser light sources providing a plurality of illuminating light beams, a lenslet array defining a plurality of focussing elements, each focussing one of the plurality of illuminating light beams, and a diffractive optical elements comprising a plurality of diffractive optical sub-elements, each sub-element being associated with one of the plurality of output light beams, and constructed to define part of an image and being impinged upon by one of the output light beam from one of the focussing elements to produce a multiplicity of diffracted beams which taken together define the image. The image preferably comprises a template to enable data entry into a data entry device. In any of the optical apparatus described in this paragraph, the array of diode laser light sources may preferably be a vertical cavity surface emitting laser (VCSEL) array.

Furthermore, in any of the above-mentioned optical apparatus, the diffractive optical element may preferably define the output window of the optical apparatus.

There is further provided in accordance with yet another preferred embodiment of the present invention an integrated laser diode package comprising a laser diode chip emitting a light beam, a beam modifying element for modifying the light beam, a focussing element for focussing the modified light beam, and a diffractive optical element to generate an image from the beam. The image preferably comprises a template to enable data entry into a data entry device.

Alternatively and preferably, there is also provided an integrated laser diode package comprising a laser diode chip emitting a light beam, and a non-periodic diffractive optical element to generate an image from the beam. In such an embodiment also, the image preferably comprises a template to enable data entry into a data entry device.

In accordance with still another preferred embodiment of the present invention, there is provided optical apparatus comprising an input illuminating beam, a non-periodic diffractive optical element onto which the illuminating beam is impinged, and a translation mechanism to vary the position of impingement of the input beam on the diffractive optical element, wherein the diffractive optical element preferably deflects the input beam onto a projection plane at an angle which varies according to a predefined function of the position of impingement. In this embodiment, the translation mechanism preferably translates the DOE. In either of the apparatus described in this paragraph, the position of the impingement may be such as to vary in a sinusoidal manner, and the predetermined function may be such as to preferably provide a linear scan. In such cases, the predetermined function is preferably such as to provide a scan generating an image having a uniform intensity.

In any of these described embodiments, the input beam may either be a collimated beam or a focussed beam. In the latter situation, the apparatus also preferably comprises a focussing lens to focus the diffracted beams onto the projection plane.

Preferably, in the above-described optical apparatus, the predefined function of the position of impingement is such as to deflect the beam in two dimensions. In such a case, the translation mechanism may translate the DOE in one dimension, or in two dimensions

There is further provided in accordance with still another preferred embodiment of the present invention, an on-axis two dimensional optical scanning apparatus, comprising a diffractive optical element, operative to deflect a beam in two dimensions as a function of the position of impingement of the beam on the diffractive optical element, a low mass support structure, on which the diffractive optical element is mounted, a first frame external to the low mass support structure, to which the low mass support is attached by first support members such that the low mass support structure can perform oscillations at a first frequency in a first direction, a second frame external to the first frame, to which the first frame is attached by second support members such that the second frame can perform oscillations at a second frequency in a second direction, and at least one drive mechanism for exciting at least one of the oscillations at the first frequency and the oscillations at the second frequency. In this apparatus, the first frequency is preferably higher than the second frequency, in which case, the scan is a raster-type scan.

In accordance with still another preferred embodiment of the present invention, there is provided optical apparatus comprising a diode laser source for emitting an illuminating beam, a lens for focussing the illumination beam onto a projection plane, a non-periodic diffractive optical element onto which the illuminating beam is impinged, and a translation mechanism to vary the position of impingement of the input beam on the diffractive optical element, wherein the diffractive optical element preferably deflects the input beam onto a projection plane at an angle which varies according to a predefined function of the position of impingement. The optical apparatus may also preferably comprise, in addition to the first lens for focussing the illumination beam onto the diffractive optical element, a second lens for focussing the deflected illumination beam onto the projection plane.

Any of the above described optical apparatus involving scanning applications may preferably be operative to project a data entry template onto the projection plane, or alternatively and preferably, may be operative to project a video image onto the projection plane.

### BRIEF DESCRIPTION OF THE DRAWINGS

The present invention will be understood and appreciated more fully from the description with follows, taken in conjunction with the drawings in which:

FIG. 1 is a simplified schematic illustration of interchangeable optics useful in a combination camera and input device constructed and operative in accordance with a preferred embodiment of the present invention;

FIG. 2 is a simplified schematic illustration of optics useful in a combination camera and input device constructed and operative in accordance with another preferred embodiment of the present invention;

FIG. 3 is a generalized schematic illustration of various alternative implementations of the optics of FIG. 2, useful in a combination camera and input device constructed and operative in accordance with a preferred embodiment of the present invention;

FIGS. 4A and 4B are respective pictorial and diagrammatic illustrations of a specific implementation of the optics of FIG. 2, useful in a combination camera and input device constructed and operative in accordance with a preferred embodiment of the present invention;

FIG. 5 is a diagrammatic illustration of a specific implementation of the optics of FIG. 2, useful in a combination camera and input device constructed and operative in accordance with a preferred embodiment of the present invention;

FIG. 6 is a diagrammatic illustration of a specific implementation of the optics of FIG. 2, useful in a combination camera and input device constructed and operative in accordance with a preferred embodiment of the present invention;

FIG. 7 is a diagrammatic illustration of a specific implementation of the optics of FIG. 2, useful in a combination camera and input device constructed and operative in accordance with a preferred embodiment of the present invention;

FIG. 8 is a diagrammatic illustration of a specific implementation of the optics of FIG. 2, useful in a combination camera and input device constructed and operative in accordance with a preferred embodiment of the present invention;

FIG. 9 is a diagrammatic illustration of a specific implementation of the optics of FIG. 2, useful in a combination camera and input device constructed and operative in accordance with a preferred embodiment of the present invention;

FIG. 10 is a diagram of reflectivity and transmission curves of existing dichroic filters useful in the embodiments of FIGS. 2-9B;

FIGS. 11A, 11B and 11C are simplified schematic illustrations of the embodiment of FIG. 3 combined with three different types of mirrors;

FIGS. 12A, 12B, 12C, 12D, 12E, 12F and 12G are simplified schematic illustrations of the seven alternative implementations of the embodiment of FIG. 3;

FIG. 13 is a simplified schematic illustration of optical apparatus, constructed and operative in accordance with a preferred embodiment of the present invention, useful for projecting templates;

FIGS. 14A and 14B are respective simplified schematic and simplified top view illustrations of an implementation of the apparatus of FIG. 13 in accordance with a preferred embodiment of the present invention;

FIGS. 15A and 15B are respective simplified top view and side view schematic illustrations of apparatus useful for projecting templates constructed and operative in accordance with another preferred embodiment of the present invention;

FIG. 16 is a simplified side view schematic illustration of apparatus useful for projecting templates constructed and operative in accordance with yet another preferred embodiment of the present invention;

FIG. 17 is a simplified side view schematic illustration of apparatus useful for projecting templates constructed and operative in accordance with still another preferred embodiment of the present invention;

FIG. 18 is a simplified schematic illustration of a laser diode package incorporating at least some of the elements shown in FIGS. 13A-15B;

FIG. 19 is a simplified schematic illustration of diffractive optical apparatus useful in scanning, useful, inter alia, in apparatus for projecting templates, constructed and operative in accordance with a preferred embodiment of the present invention;

FIG. 20 is a simplified schematic illustration of diffractive optical apparatus useful in scanning, useful, inter alia, in apparatus for projecting templates, constructed and operative in accordance with another preferred embodiment of the present invention;

FIG. 21 is a simplified illustration of the use of a diffractive optical element for two-dimensional scanning;

FIG. 22 is a simplified illustration for two-dimensional displacement of a diffractive optical element useful in the embodiment of FIG. 21;

FIG. 23 is a simplified schematic illustration of diffractive optical apparatus useful in scanning, useful, inter alia, in apparatus for projecting templates, constructed and operative in accordance with a preferred embodiment of the present invention, employing the apparatus of FIG. 22; and

FIG. 24 is a simplified schematic illustration of diffractive optical apparatus useful in scanning, useful, inter alia, in apparatus for projecting templates, constructed and operative in accordance with another preferred embodiment of the present invention employing the apparatus of FIG. 22.

### DETAILED DESCRIPTION OF PREFERRED EMBODIMENTS

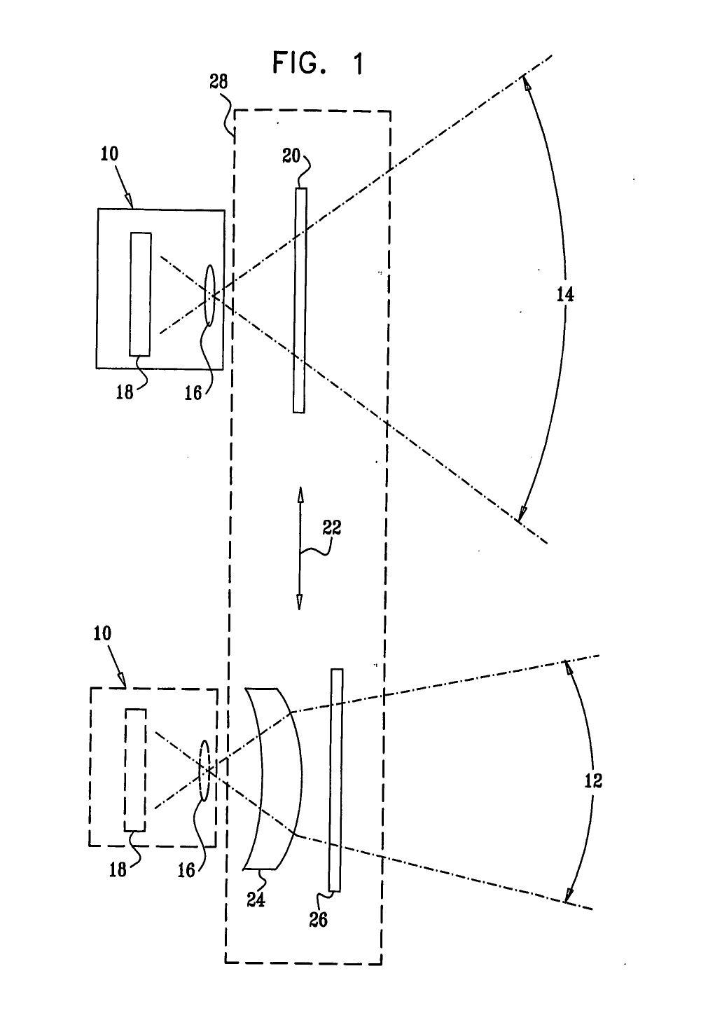

Reference is now made to FIG. 1, which is a simplified schematic illustration of interchangeable optics useful in a combination camera and input device constructed and operative in accordance with a preferred embodiment of the present invention. Such a camera and input device could be incorporated into a cellular telephone, a personal digital assistant, a remote control, or similar device. In the embodiment of FIG. 1, a dual function CMOS camera module 10 provides both ordinary color imaging of a moderate field of view 12 and virtual interface sensing of a wide field of view 14.

As described in the PCT Application published as International Publication No. WO 2004/003656, the disclosure of which is hereby incorporated by reference in its entirety, an imaging lens for imaging in a virtual interface mode is required to be positioned with very high mechanical accuracy and reproducibility in order to obtain precise image calibration.

In the embodiment of FIG. 1, in camera module 10, a wide field imaging lens 16 is fixed in front of a CMOS camera 18. A virtual interface can thus be precisely calibrated to a high level of accuracy during system manufacture.

When CMOS module 10 is employed in a virtual interface mode, as shown at the top of FIG. 1, an infra-red transmissive filter 20 is positioned in front of the wide angle lens 16. This filter need not be positioned precisely relative to module 10 and thus a simple mechanical positioning mechanism 22 can be employed for this purpose.

When the CMOS camera module 10 is used for general-purpose color imaging, as is shown in phantom lines at the bottom of FIG. 1, positioning mechanism 22 is operative such that infrared filter 20 is replaced in front of the camera module by a field narrowing lens 24 and an infrared blocking filter 26. In this imaging mode as well, accurate lateral positioning of the field-narrowing lens 24 is not important since the user can generally align the camera in order to frame the picture appropriately, such that a simple mechanical mechanism can be employed for this positioning function.

Although in the preferred embodiment shown in FIG. 1, the mechanical positioning arrangement is shown as a single interchangeable optics unit 28, which is selectably positioned in front of the camera module 10 by a single simple mechanical positioning mechanism 22, according to the type of imaging field required, it is appreciated that the invention is understood to be equally applicable to other mechanical positioning arrangements, such as, for instance, where each set of optics for each field of view is moved into position in front of module 10 by a separate mechanism.

Furthermore, although in FIG. 1, only one general-purpose color imaging position is shown, it is to be understood that different types of imaging functionalities can be provided here, whether for general purpose video or still recording, or in close-up photography, or in any other color imaging application, each of these functionalities generally requiring its own field imaging optics. The positioning mechanism 22 is then adapted to enable switching between the virtual interface mode and any of the installed color imaging modes.

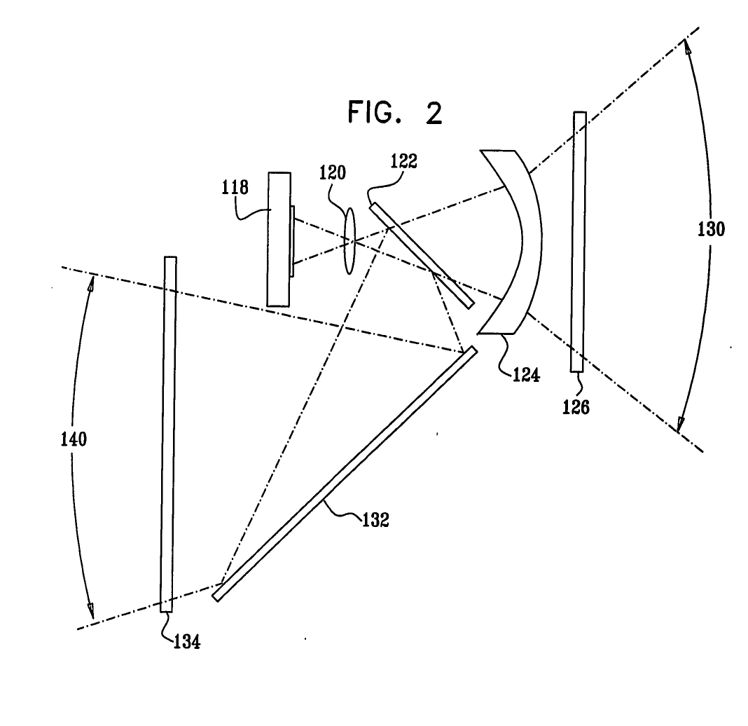

The embodiment shown in FIG. 1 requires mechanically moving parts, which complicates construction, and may be a source of unreliability, compared with a static optical design. Reference is now made to FIGS. 2 to 9B, which show schematic illustrations of improved optical designs for a dual mode CMOS image sensor, providing essentially the same functions as those described hereinabove with respect to FIG. 1, but which require no moving parts.

Referring now to FIG. 2, a CMOS camera 118 and an associated intermediate field of view lens 120 are positioned behind a dichroic mirror 122, which transmits infrared light and reflects visible light over at least a range of angles corresponding to the field of view of the lens 120. A field expansion lens 124 and an infrared transmissive filter 126 which blocks visible light are positioned along an infrared transmission path. It is appreciated that the above-mentioned arrangement provides an infrared virtual interface sensing system having a wide field of view 130.

A normally reflective visible light mirror 132 and an infra-red blocking filter 134 are positioned along a visible light path, thus providing color imaging capability over a medium field of view 140.

The embodiment of FIG. 2 has an advantage in that the two imaging pathways are separated and lie on opposite sides of the device. This is a particularly useful feature when incorporating the dual mode optical module in mobile devices such as mobile telephones and personal digital assistants where it is desired to take a picture in the direction opposite to the side of the device in which the screen is located, in order to use the screen to frame the picture, and on the other hand, to provide virtual input capability at the same side as the device as the screen in order to visualize data that is being input.

Reference is now made to FIG. 3, which is a schematic illustration of a further preferred embodiment of the present invention, showing beam paths for a dual-mode optics module, combining a visible light imaging system having a narrow field of view 300, 302, 304, for picture taking, which can be optionally directed to the back 300, side 302 or front 304 of the device, with a wide field of view, infra-red imaging path facing forwards from the front of the device for virtual keyboard functionality. For simplicity, the beam paths are only shown in FIG. 3 over half 310 of the wide field of view.

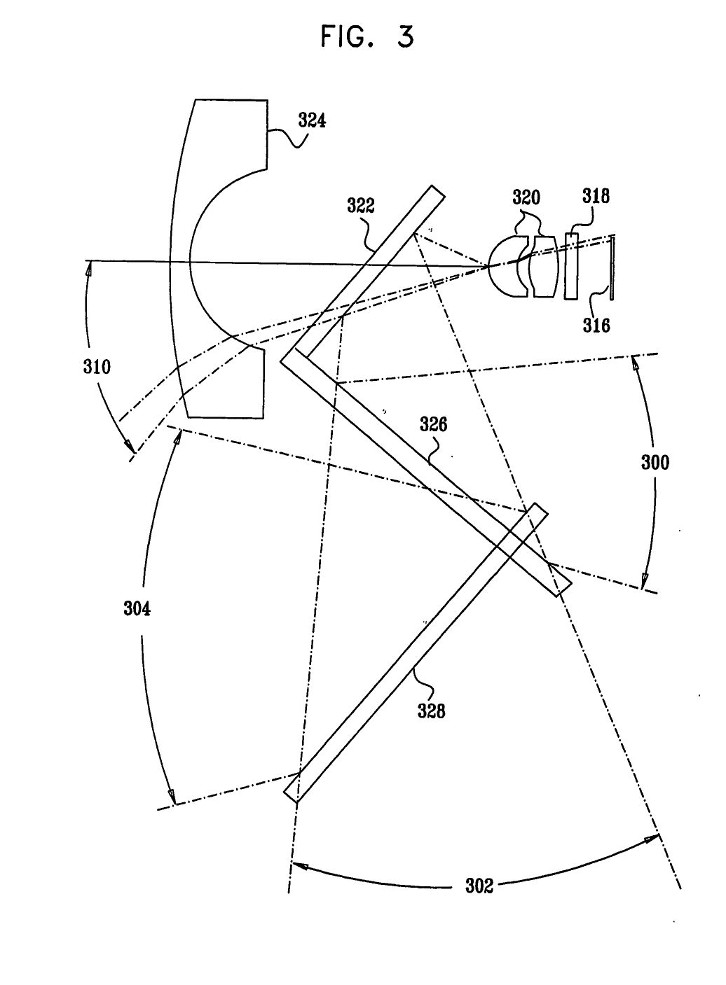

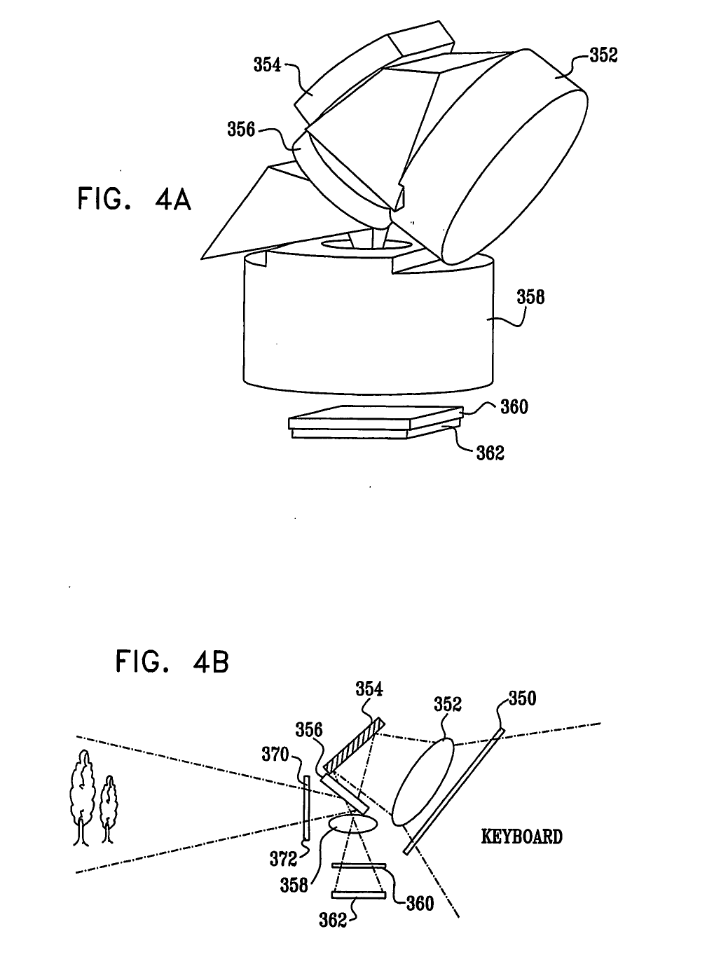

As seen in FIG. 3, a CMOS camera 316 receives light via an LP filter 318, lenses 320 and a dichroic mirror 322. Infra-red light is transmitted through dichroic mirror 322 via a wide field of view lens 324. Visible light from a narrow field of view located at the back of the device is reflected by full reflector mirror 326 onto a dichroic mirror 322, from where it is reflected into the camera focussing assembly; that from the front of the device by full reflector mirror 328 to the dichroic mirror 322; and that from the side of the device passes without reflection directly to the dichroic mirror 322. Either of the mirrors 326, 328, may preferably be switched into position, or neither of them, according to which of the specific narrow fields of view it is desired to image. Details of various specific embodiments of FIGS. 2 and 3 are shown in the following FIGS. 4A to 9.

Reference is now made to FIGS. 4A & 4B, which are respective pictorial and diagrammatic illustrations of a specific implementation of the embodiment of FIG. 2 or 3, useful in a combination camera and data input device constructed and operative in accordance with a preferred embodiment of the present invention. This specific dual optics implementation incorporates a vertical facing camera, and each optical path is turned by a single mirror, thus enabling a particularly compact solution. Infra-red light received from a virtual keyboard passes along a pathway defined by a shutter 350 and a field expander lens 352 and is reflected by a mirror 354 through a dichroic combiner 356, a conventional camera lens 358 and an interference filter 360 to a camera 362, such as a CMOS camera. Visible light from a scene passes along a pathway defined by a shutter 370 and IR blocking filter 372 and is reflected by the dichroic combiner 356 through lens 358 and interference filter 360 to camera 362. It is appreciated that shutter 370 and IR blocking filter 372 can be combined into a single device, as shown, or can be separate devices.

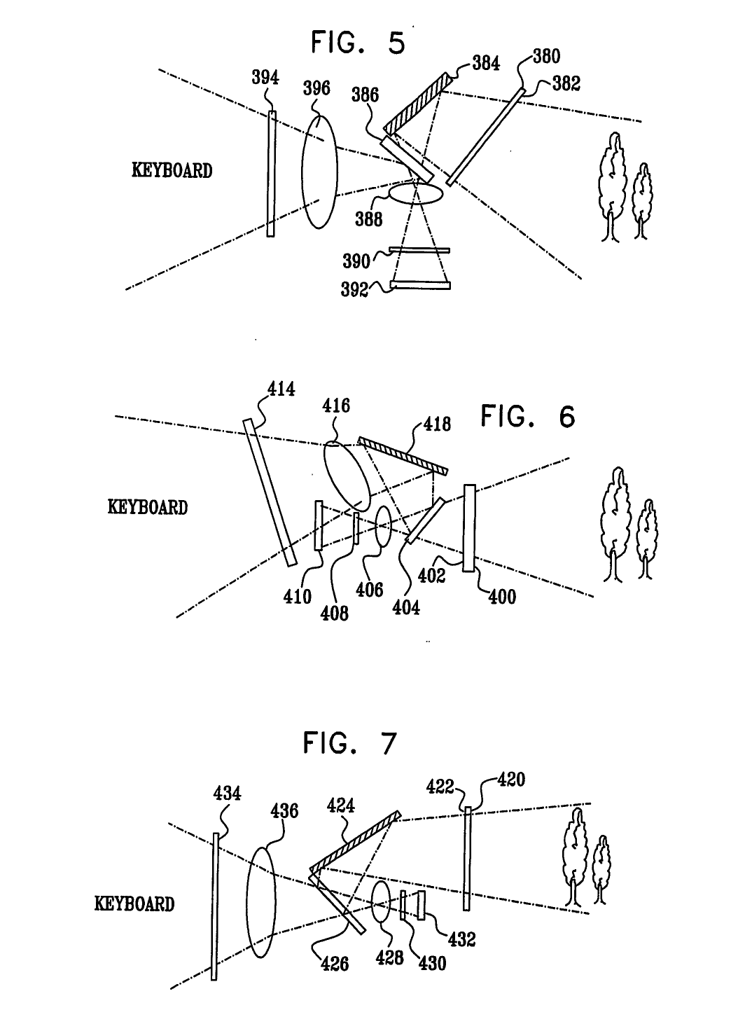

Reference is now made to FIG. 5, which is a diagrammatic illustration of another specific implementation of the embodiments of FIG. 2, useful in a combination camera and data input device constructed and operative in accordance with a preferred embodiment of the present invention employing many of the same elements as the embodiment of FIGS. 4A and 4B, and which too is a very compact embodiment. Visible light received from a scene passes along a pathway defined by a shutter 380 and IR blocking filter 382 and is reflected by a mirror 384 through a dichroic combiner 386, a conventional camera lens 388 and an interference filter 390 to a camera 392, such as a CMOS camera. Infra-red light from a virtual keyboard passes along a pathway defined by a shutter 394 and a field expander lens 396 and is reflected by the dichroic combiner 386 through lens 388 and interference filter 390 to camera 392. It is appreciated that shutter 380 and IR blocking filter 382 can be combined into a single device, as shown, or can be separate devices.

Reference is now made to FIG. 6, which is a diagrammatic illustration of a specific implementation of the embodiment of FIG. 2, useful in a combination camera and input device constructed and operative in accordance with a preferred embodiment of the present invention, and to FIG. 7, which shows a variation of the embodiment of FIG. 6. This embodiment is characterized in that a horizontal facing camera and one optical path points directly out of a device and a second optical path is turned by two mirrors to point in the opposite direction. This has the advantage that the camera component is mounted generally parallel to all the other components of the device and can be assembled on the same printed circuit board as the rest of the device.

Turning specifically to FIG. 6, in which embodiment, the scene is imaged directly, and the virtual keyboard after two reflections, it is seen that visible light received from a scene passes along a pathway defined by a shutter 400 and IR blocking filter 402 and passes through a dichroic combiner 404, a conventional camera lens 406 and an interference filter 408 to a camera 410, such as a CMOS camera. Infra-red light from a virtual keyboard passes along a pathway defined by a shutter 414 and a field expander lens 416 and is reflected by a mirror 418 and by the dichroic combiner 404 through lens 406, interference filter 408 and camera 410. It is appreciated that shutter 400 and IR blocking filter 402 can be combined into a single device, as shown, or can be separate devices.

Turning specifically to FIG. 7, in which embodiment, the virtual keyboard is imaged directly, and the scene after two reflections, it is seen that visible light received from a scene passes along a pathway defined by a shutter 420 and IR blocking filter 422 and is reflected by a mirror 424 and by a dichroic combiner 426 through a lens 428, an interference filter 430 and a camera 432, such as a CMOS camera. Infra-red light from a virtual keyboard passes along a pathway defined by a shutter 434 through a field expander lens 436, through dichroic combiner 426, lens 428 and interference filter 430 to camera 432, such as a CMOS camera. It is appreciated that shutter 420 and IR blocking filter 422 can be combined into a single device, as shown, or can be separate devices.

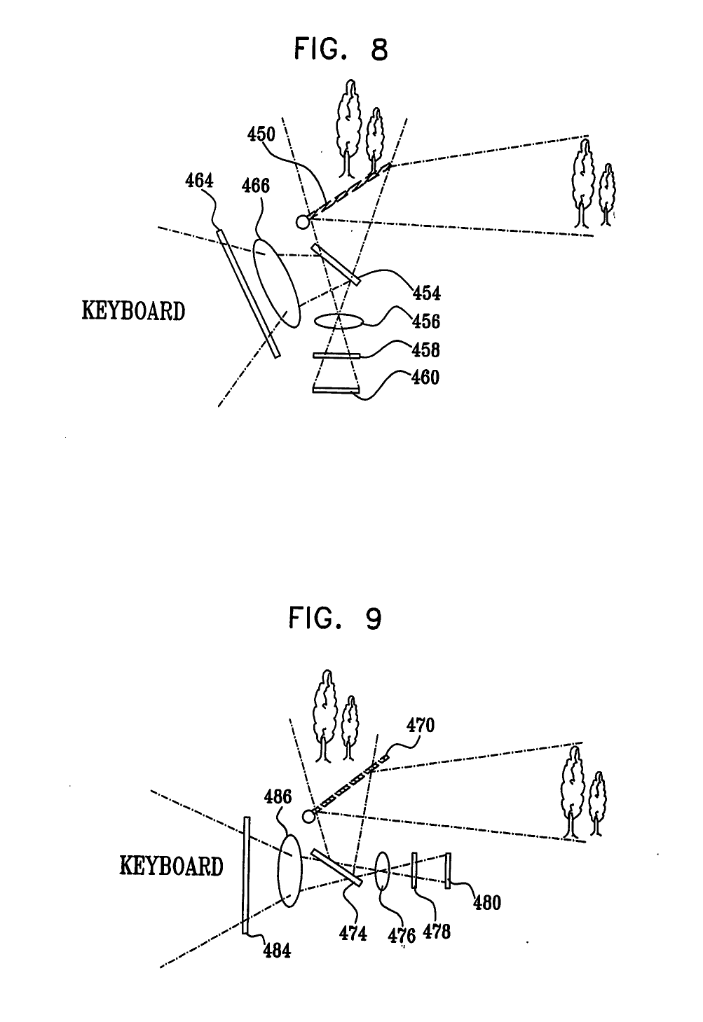

Reference is now made to FIG. 8, which is a diagrammatic illustration of a specific implementation of the optics of FIG. 2 or 3, useful in a combination camera and input device constructed and operative in accordance with a preferred embodiment of the present invention, and to FIG. 9, which is a diagrammatic illustration of another specific implementation of the optics of FIG. 2 or 3, similar to that of FIG. 8. The embodiments of FIGS. 8 and 9 are characterized in that they employ both horizontal and vertical sensors and a pivotable mirror which may also function as a shutter so that only a single internal mirror is needed inside the device to separate the beam paths.

Turning specifically to FIG. 8, it is seen that visible light received from a scene may be reflected by a pivotable mirror 450 along a pathway which passes through a dichroic combiner 454, a conventional camera lens 456 and an interference filter 458 to a camera 460, such as a CMOS camera. The pivotable mirror 450 is also operative as the main shutter to block of the visible imaging facility. When a sideways scene is to be imaged, the pivotable mirror 450 is swung right out of the beam path, as indicated by a vertical orientation in the sense of FIG. 8. Infra-red light from a virtual keyboard passes along a generally horizontal pathway, in the sense of FIG. 8, defined by a shutter 464 and a field expander lens 466 and is reflected by dichroic combiner 454 through lens 456, interference filter 458 and into camera 460.

Referring specifically to FIG. 9, it is seen that visible light received from a scene may be reflected by a pivotable mirror 470 along a pathway which is reflected by a dichroic combiner 474, a conventional camera lens 476 and an interference filter 478 to a camera 480, such as a CMOS camera. The pivotable mirror 470 is also operative as the main shutter to block of the visible imaging facility. When a sideways scene is to be imaged, the pivotable mirror 470 is swung right out of the beam path, as indicated by a vertical orientation in the sense of FIG. 9B. Infra-red light from a virtual keyboard passes along a generally horizontal pathway in the sense of FIGS. 9A & 9B, defined by a shutter 484 and a field expander lens 486 and is by dichroic combiner 474, through lens 476, interference filter 478 and into camera 480.

In the devices described in the embodiments of FIGS. 2-9 above, when the VKB mode is being imaged, only the region around the IR illuminating wavelength, generally the 785 nm region, is transmitted to the camera. This is preferably achieved by using a combination of IR cut-on and IR cut-off filters. On the other hand, the other modes of using the device, such as for video conferencing, for video or snapshot imaging, or for close-up photography, generally require that only the visible region is passed onto the camera. This means that when a single camera module is used for both modes, the spectral filters have to be switched in or out of the beam path according to the mode selected.

Reference is now made to FIG. 10A, which is a diagram of transmission curves of filters useful in the embodiments of FIGS. 2-9. FIG. 10A shows in trace A, characteristics of a conventional IR cut-off filter which blocks the near IR region. Such an IR cut-off filter can be realized as an absorption filter or as an interference filter, and is preferably used in the visible imaging mode paths, in order to block the VKB illumination from interfering with the visible image. In the embodiments of FIGS. 2-9, when the device is being used in the VKB imaging mode, the conventional cut-off filter should be replaced by a filter which passes only the VKB illuminating IR region. This can preferably be implemented by using two filters; a cut on filter, whose transmission characteristics are shown in FIG. 10A as trace B, and a LP interference filter whose transmission characteristics are shown in FIG. 10A as traces C1 and C2 for two different angles of incidence.

Reference is now made to FIG. 10B, which is a diagram of an alternative and preferable filter arrangement for use in the embodiments of FIGS. 2-9, in which a single narrow pass interference filter, marked D in the graph, having a preferred passband of 770 to 820 nm, is used for the VKB imaging channel, along with a visible filter marked E, with a 400 to 700 nm., passband. The IR blocking filter marked E is used for the visible modes to avoid interference of the image by the VKB IR illumination, or by background NIR illumination.

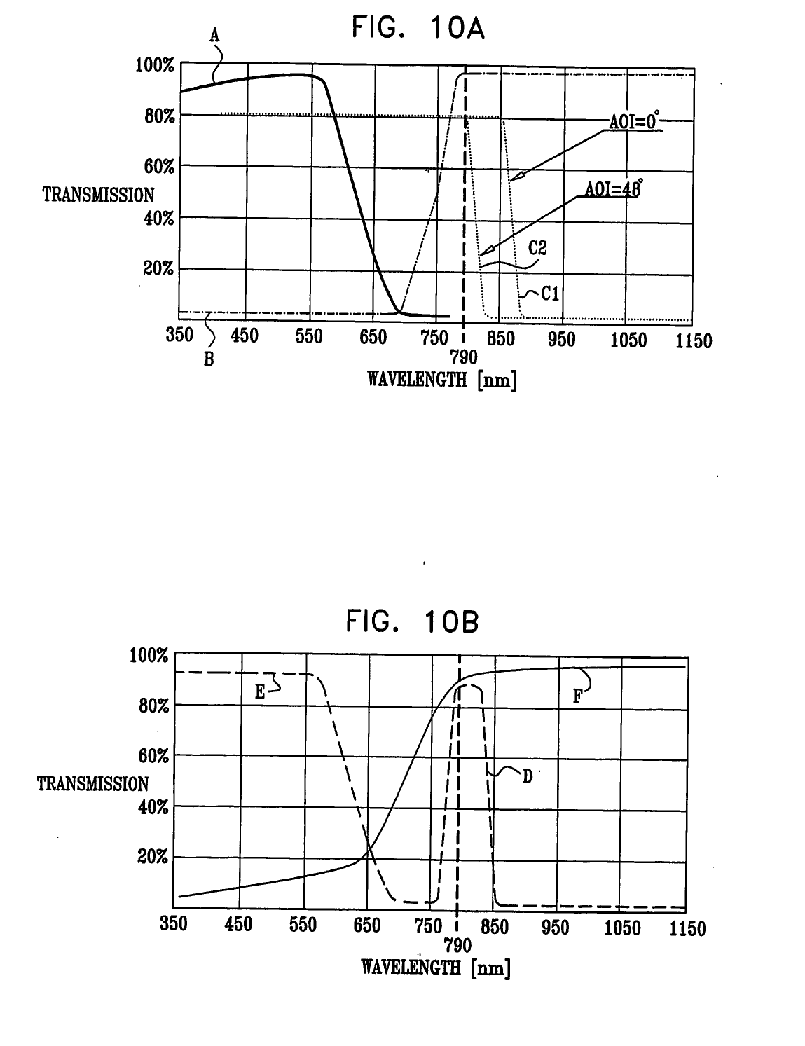

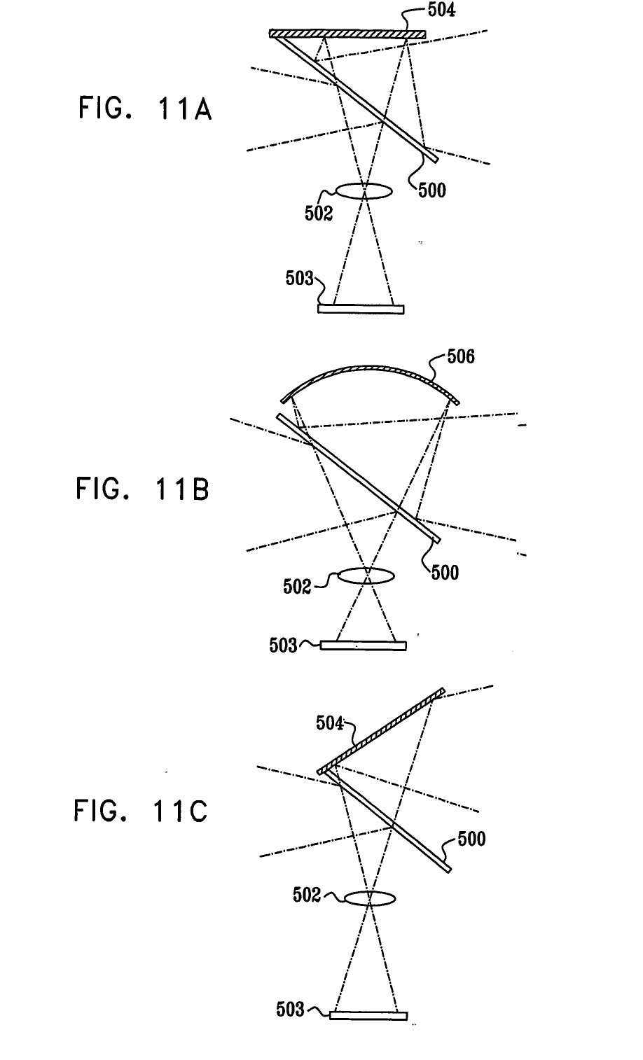

Reference is now made to FIGS. 11A, 11B and 11C, which are simplified schematic illustrations of the embodiment of FIG. 3 combined with three different types of mirrors. All of the embodiments shown in FIGS. 11A-11C relate to the use of a single camera for imaging different fields of view along different optical paths. All paths are imaged upon the focal plane of the camera, but only one path is employed at any given time. Each path represents a separate operating mode that may be toggled into an active state by the user. None of the embodiments of FIGS. 11A, 11B and 11C include moving parts.

Turning to FIG. 11A, it is seen that light coming from the left in the sense of FIG. 11A, is fully or partially reflected by a spectrally normal beam splitting mirror, or a dichroic mirror 500 towards camera optics 502, and then into the camera 503. The particular mirror combination used depends on the spectral content of each channel. When both channels are visible light channels, a normal beam splitting mirror 500 is used. When one of the channels is in the infra red, a dichroic partially reflective mirror 500 is used. Light coming from the right is reflected twice; typically 50% by the mirror 500 and fully by a top mirror 504, and is steered again through the mirror 500 towards the camera optics 502 and camera 503. This mode enables 50% transmission from the left path and 25% from the right path.

FIG. 11B shows an arrangement which is similar to that of FIG. 11A. In FIG. 11B, however, the top mirror is replaced by a concave mirror 506 in order to provide a wider field of view.

The embodiments of FIGS. 11A and 11B can also be implemented using a pair of prisms.

In the embodiment of FIG. 11C, the top mirror 504 is tilted upwardly with respect to its orientation in FIG. 11A and the mirror 500 is not employed for reflection of the beam coming from the right of the drawing. This arrangement has substantially the same performance as the embodiment of FIG. 11A, but has a larger size.

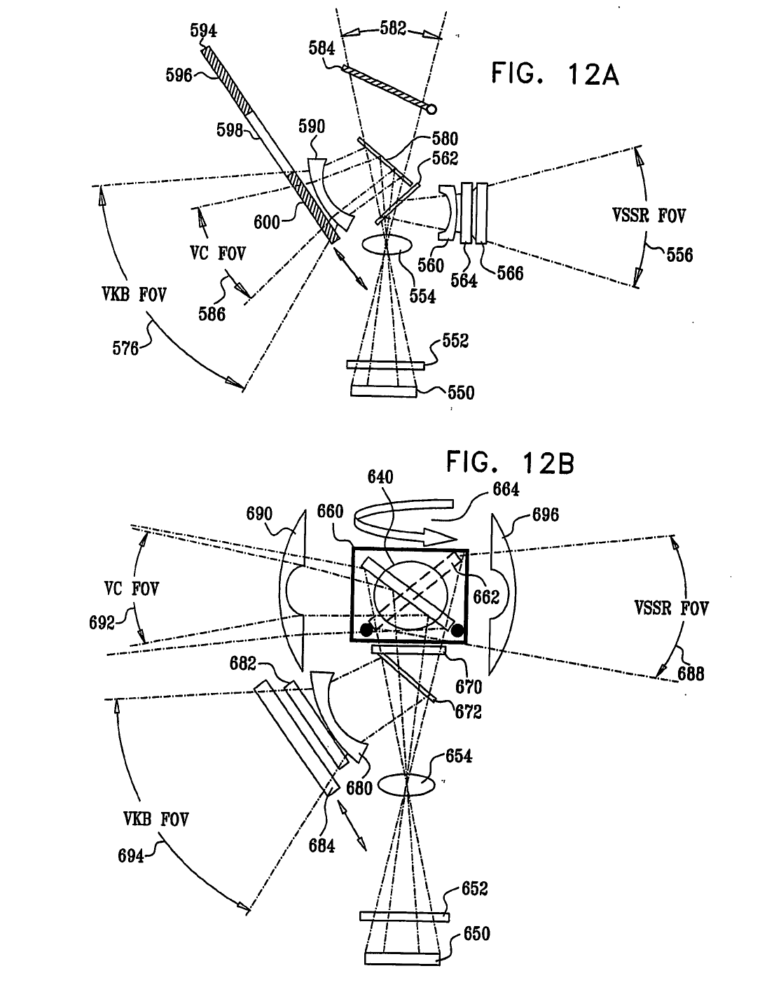

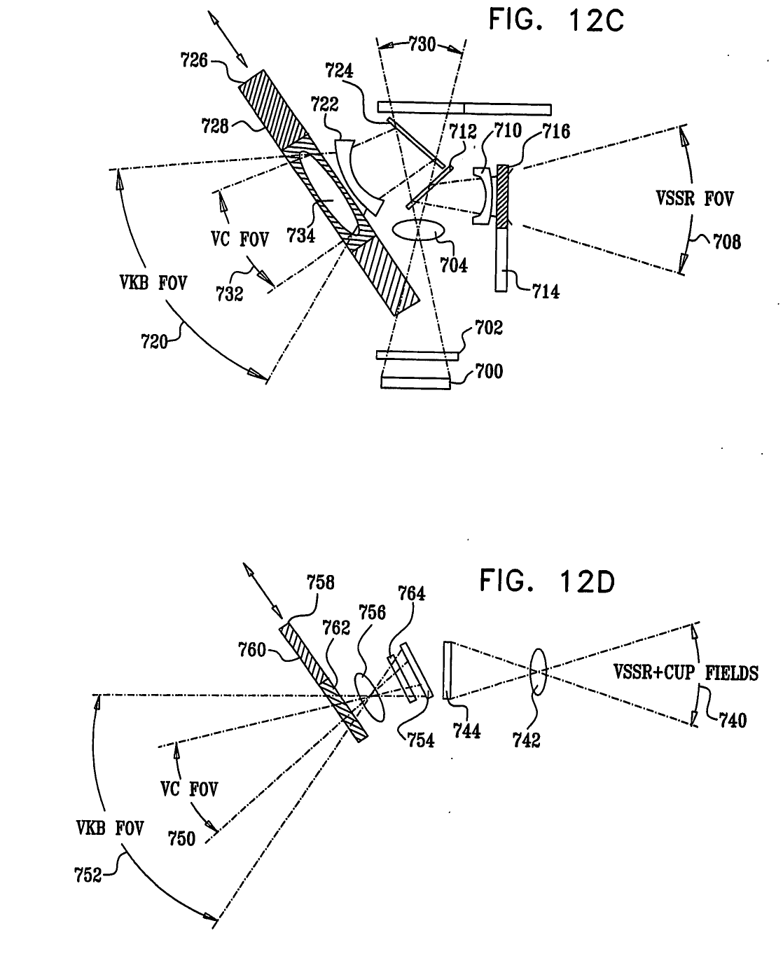

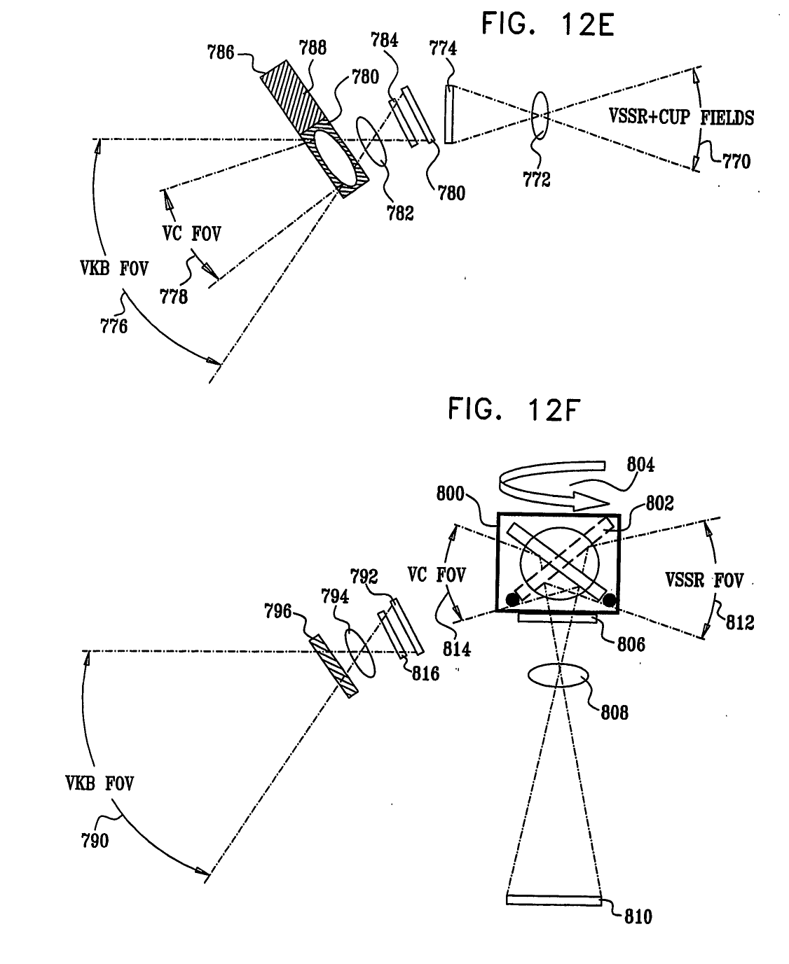

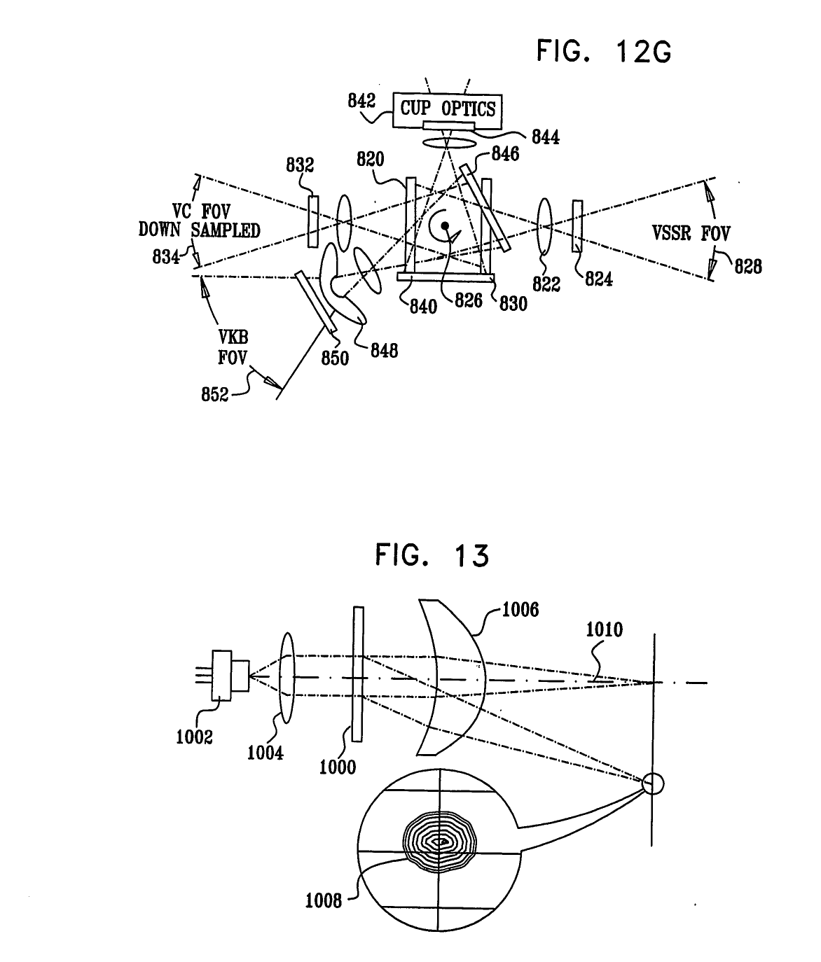

Reference is now made to FIGS. 12A, 12B, 12C, 12D, 12E, 12F and 12G, which are simplified schematic illustrations of seven alternative implementations of the embodiment of FIG. 3.

Table 1 sets forth essential characteristics of each of the seven embodiments, which are described in detail hereinbelow:

TABLE 1
Summary of realizations of four optical fields in a mobile handset

| | | | | CUP - rear/side | |
|---|---|---|---|---|---|
| FIG. | Cam. | VSSR - rear field | VC - front field | field | VKB - front field |
| 12A | HR | Full FIELD OF | HR partial FIELD OF | External/internal | DS full field |
| | | VIEW | VIEW WDWG toggled | macro | Toggled to mode |
| | | Dedicated field | to mode | | |
| 12B | HR | VMS - VSSR | VMS - VC station | VMS - macro station | DS full field |
| | | station | DS (WDWG) | | Dedicated field |
| | | Full FIELD OF | | | |
| | | VIEW | | | |
| 12C | HR | Full FIELD OF | DS partial field | External/internal | DS full field |
| | | VIEW | Toggled to mode | macro | Toggled to mode |
| 12D | HR + | Full FIELD OF | WDWG partial FIELD | External/internal | DS full field |
| | HR | VIEW | OF VIEW | macro | Toggled to mode |
| | | Separate HR cam | Toggled to mode | | |
| 12E | HR + | Full FIELD OF | WDWG partial FIELD | External/internal | Full FIELD OF |
| | LR/HR | VIEW | OF VIEW | macro | VIEW LR or DS HR |
| | | Separate HR cam | Full LR or DS HR | HR | Toggled to mode |
| | | | Toggled to mode | | |
| 12F | HR + | VMS - VSSR | VMS - VC station | VMS - macro station | LR |
| | LR | station | DS (WDWG) HR | HR | Dedicated cam |
| | | Full FIELD OF | | | |
| | | VIEW HR | | | |
| 12G | HR | HS - VSSR station | HS - VC station | HS - macro station | HS - VKB station |
| | | Full FIELD OF | DS (WDWG) | | DS |
| | | VIEW | | | |

Notes:
WDWG = Windowing, DS = Down-Sampling, HS = Horizontal Swiveling, VSSR = Video and SnapShot Recording, VC = Video Conferencing, CUP = Close Up Photography, VMS = Vertical Mirror Swiveling, HR = High Resolution Camera, LR = Low Resolution Camera

Turning to FIG. 12A, which is an embodiment providing up to four fields of view in one camera without any moving optics, it is seen that common optics are provided for all four fields of view and include a high-resolution color camera 550, typically a VGA or 1.3M pixel camera, with an entrance aperture interference filter 552, such as is shown in FIG. 10A or 10B preferably comprising a visible transmissive filter together with a filter for transmitting the 780 nm IR illumination, either as a specific bandpass filter, or as a Lowpass filter, and a lens 554 having a narrow field of view of about 20°. Preferred optical arrangements for these four fields of view are now described.

The VSSR field of view 556 is preferably captured through an optional field lens 560 in order to expand the field of view by a factor of approximately 1.5 and a combiner 562. The VSSR field of view employs a fixed IR cut-off window 564 that is covered by an opaque slide shutter 566 for enabling/disabling passage of light from the VSSR field of view. Preferably, the optics for this field of view have a low distortion (<2.5%) and support the resolution of the camera 550, preferably a Modulation Transfer Function MTF of approximately 50% at 50 cy/mm for a VGA camera, and an MTF of approximately 60% at 70 cy/mm for a 1.3M camera.

The VKB field of view 576 and the VC field of view 586 are preferably captured via a large angle field lens 590 that may expand the field of view of the common optics by a factor of up to 4.5, depending upon the geometry. The center section of the field of view of lens 590, e.g. the VC field of view, is preferably designed for obtaining images in the visible part of the spectrum, and has a distortion level of less than 4% and resolution of approximately 60% at 70 cy/mm. The remainder of the field of view of lens 590, e.g. the VKB field of view, may have a higher level of distortion, up to 25%, and lower resolution, typically less than 20% at 20 cy/mm at 785 nm.

In front of lens 590 there is preferably provided a triple position slider or rotation shutter 594 having three operative regions, an opaque region 596, an IR cut-off region 598 for providing true color video and an IR cut-on filter region 600 for sensing IR from a virtual keyboard. Suitable positioning of shutter 594 at region 600 for the VC field of view enables low resolution IR imaging to be realized when a suitable IR source, such as an IR LED is employed.

The light from field lens 590 is reflected by means of a flat reflective element 580 down towards the camera optics 554 and camera 550. In the simplest triple field of view embodiment, this flat reflective element 580 is a full mirror. When an additional optional fourth field of view is utilized, as described below, this flat reflective element 580 is a dichroic beam combiner.

An optional additional field of view 582 can be provided when the flat reflective element 580 is a dichroic mirror or beam combiner Since both combiners 562 and 580 are flat windows, they will cause minimal distortion to the image quality. In front of this field 582, there should be an enabling/disabling shutter. A pivoted mirror 584 enables this additional field of view to be that above the camera, in the sense of FIG. 12A, or when suitably aligned, to the side of the camera. Alternatively, if only the top field is to be used, it can be a slide shutter.

The CUP field of view may be provided internally by employing a variable field lens in the VSSR path 556 or externally by employing an add-on macro lens in front of the VSSR field 556 or the optional field 582, as is done in the Nokia 3650 and Nokia 3660 products. In the latter case the upper mirror 580 should be a dichroic combiner transmissive for visible light and highly reflective to 785 nm light. This optional field should also have a disable/enable shutter (sliding or flipping) in front of a IR cut-off window, also not shown in FIG. 12A.

Reference is now made to FIG. 12B, which is an embodiment providing four fields of view in one camera, but, unlike the embodiment of FIG. 12A, employing a swiveled mirror head where it is seen that common optics are provided for all four fields of view and include a high-resolution color camera 650, typically a VGA or 1.3M pixel camera, with an entrance aperture filter, preferably an interference filter 652, such as is shown in FIG. 10A or 10B, preferably comprising a visible transmissive filter together with a filter for transmitting the 780 nm IR illumination, either as a specific bandpass filter, or as a Lowpass filter, and a lens 654 having a narrow field of view of about 20°

A top swivel head 660 comprises a tilted mirror 662 mounted on a rotating base 664, shown in FIG. 12B schematically by the circular arrow above the swivel head. Mirror 662 may be fixed in a predetermined tilted position or alternatively may be pivotably mounted. Selectably disabling of the passage of light through the swivel head 660 may be achieved, for example when a fixed tilted mirror is employed, by rotating the head to a dummy position at which no light can enter. Alternatively, when a pivotably mounted tilted mirror is employed, the mirror may be pivoted to a position at which no light can enter.

Although the swivel head can rotate 664 and capture an image in any direction, however it is believed to be more useful to define discrete imaging stations. Movement between stations may require the rotation of the image on the screen. The image obtained is a mirror image, which can be corrected electronically if needed. An entrance aperture 640 is shown in the swivel head, pointed out of the plane of the drawing.

An IR cut-off filter 670 is positioned just under the swivel head 660 to enable a true color picture to be captured. The light from the swivel head 660 passes via a dichroic combiner 672 to a CMOS camera 650. Additional optics (not shown in FIG. 12B) may be provided facing each station of the swivel head to enable a given field of view to be suitably imaged.

Preferred optical arrangements for these four fields of view are now described.

VKB mode—A field lens 680 for the VKB mode captures a large field of view 694 of up to about 90° depending upon the geometry. An IR cut-on filter plastic window 682 is positioned in front of the field lens. The captured IR light is steered by means of a dichroic mirror 672 to the common optics. The IR image obtained upon the CMOS may preferably be of low quality, with barrel distortion of up to 25% and an MTF of about 20% at 20 cy/mm at 785 nm). To turn on the VKB mode an opaque shutter 684 has to be opened, and the top swivel head rotated to a disabling position.

A VSSR mode is obtained by enabling the top swivel head 660 for VSSR imaging, and rotating it to the VSSR station position that is at the rear part of the handset, such that, through the VSSR field lens 696, which expands the field of view by a factor of approximately 1.5, the VSSR field of view 688 is imaged.

A VC mode is obtained by enabling the top swivel head 660 and rotating it to the VC station position that is at the front side of the handset, where the LCD is located, such that the VC field of view 692 is imaged by use of the optional optical element 690. Using this option, only part of the COMS imaging plane is utilized, this being known as the windowing option. When the optic 690 is not present, the original FOV of the lens 654 captures the image upon the entire camera sensing area but is down sampled to give the lower resolution VC image, this being known as the down sampling option.

A CUP mode could be realized by one of the methods described above in relation to the embodiment of FIG. 12A.

Reference is now made to FIG. 12C, which is an embodiment providing four fields of view in one camera, with moving inline optics for the VC field of view. It is seen that common optics are provided for all four fields of view and include a high-resolution color camera 700, typically a VGA or 1.3M pixel camera, with an entrance aperture interference filter 702, such as is shown in FIG. 10A or 10B, preferably comprising a visible transmissive filter together with a filter for transmitting the 780 nm IR illumination, either as a specific bandpass filter, or as a Lowpass filter, and a lens 704 having a narrow field of view of about 20°. Preferred optical arrangements for these four fields of view are now described.

The VSSR field 708 is captured through an additional field lens 710 to expand the field of view by a factor of approximately 1.5 and a dichroic combiner 712. The VSSR field preferably has a fixed/sliding IR cut-off window 714 and an opaque slide shutter 716 for enabling/disabling the imaging path. The optics for the VSSR field should have a low distortion of <2.5%, and should support the camera resolution, which for the VGA camera should provide an MTF of approximately at least 50% at 50 cy/mm, and for a 1.3M camera, an MTF of approximately at least 60% at 70 cy/mm.

The VKB field of view 720 is captured via a large angle field lens 722 that preferably expands the common optics field of view by a factor of up to 4.5, depending upon the geometry chosen, and is steered to the common optics by means of a mirror 724 and via the dichroic combiner 712. The field of view for the VKB mode may be of low quality, having a level of distortion of up to 25%, and a low resolution of typically less than 20% at 20 cy/mm at 785 nm. When the VKB mode is active, the mode selection slider 726 is positioned to the IR cut-on filter position 728, which can preferably be a suitable black plastic window.

An additional optional field 730 can also be provided, using additional components exactly like those shown in the embodiment of FIG. 12A, but not shown in FIG. 12C.

The VC field mode 732 is obtained when the triple mode selection slider 726 is positioned with the field shrinking element 734, in front of the large angle field lens 722, this being the position shown in FIG. 12C. This setting decreases the field of view to approximately 30° and focuses the image onto the entire CMOS active area in the camera 700. Also, this option filters out the near IR by an IR cut-off filter, which is incorporated in the field shrinking element 734. Since for the VC mode only CIF resolution is required, in which the camera is switched to a down sampling mode, the optical resolution is required to be about 60% at 35 cy/mm for the visible range, and the distortion should be preferably less than 4%. Although this option involves the use of moving optics 734, since the image resolution is not required to be exceptionally good, construction with a mechanical repeatability of 0.05 mm would appear to be sufficient, and such repeatability is readily obtained without the need for high precision mechanical construction techniques.

A CUP mode could be realized by one of the methods described above in relation to the embodiment of FIG. 12A.

Reference is now made to FIG. 12D, which is an embodiment providing four fields of view using two cameras, but without the need for any moving optics. Preferred optical arrangements for these four fields of view are now described.

The VSSR field 740 is achieved using a focussing lens 742 and a conventional camera 744 having either a VGA or a 1.3M pixel resolution. This same camera can also be preferably used for CUP mode imaging, either externally by use of an add-on macro module, as is done in the Nokia 3650/Nokia 3660 product, or internally by using modules such as the FDK and Macnica's FMZ10 or the Sharp LZOP3726 module.

A CUP mode could be realized by one of the methods described above in relation to the embodiment of FIG. 12A.

The VC field 750 and the VKB field 752 modes preferably use a high-resolution camera 754, such as a VGA or 1.3M pixel resolution camera, with large field of view optics 756, having a field of view of up to 90°, depending on the VKB geometry used. A filter, preferably an interference filter 764, such as is shown in FIG. 10A or 10B, preferably comprising a visible transmissive filter together with a filter for transmitting the 780 nm IR illumination, either as a specific bandpass filter, or as a Lowpass filter, is preferably disposed in front of the camera 754. The mode selection slider 758 in this embodiment preferably uses only two positions, one for the VKB mode and one for the VC mode. In the VKB mode the slider locates an IR cut-on window filter 760 in front of the lens 756. In the VC mode, the slider locates an IR cut-off window filter 762 in front of the lens 756.

In the VC mode, the camera is operative in a windowing mode, where only the center of the field is used. For this mode, a field of view of 30° is used. This field of view should preferably have a distortion level of less than 4% and an MTF of at least approximately 60% at 70 cy/mm in the visible.

In the VKB mode, a large field of view of up to 90° is required, but a higher level of distortion of up to 25% can be tolerated, and the resolution can be lower, typically less than 20% at 20 cy/mm at 785 nm. In this mode the camera is preferably operated in a windowing mode vertically, and also preferably in a down-sampling mode horizontally.

Reference is now made to FIG. 12E, which is an embodiment providing four fields of view using two cameras, but using moving in-line optics for the VC field of view. Preferred optical arrangements for these four fields of view are now described.

The VSSR field 770 is achieved using a focussing lens 772 and a conventional camera 774 having either a VGA or a 1.3M pixel resolution. This same camera can also be preferably used for CUP mode imaging, either externally by use of an add-on macro module, as is done in the Nokia 3650/Nokia 3660 product, or internally by using modules such as the FDK and Macnica's FMZ10 or the Sharp LZOP3726 module. A CUP mode could be realized by one of the methods described above in relation to the embodiment of FIG. 12A.

The VC field of view 776 mode and the VKB field of view 778 mode both preferably use a low-resolution camera 780, or a high resolution camera in a down-sampling mode. A filter, preferably an interference filter 784, such as is shown in FIG. 10A or 10B, preferably comprising a visible transmissive filter together with a filter for transmitting the 780 nm IR illumination, either as a specific bandpass filter, or as a Lowpass filter, is preferably disposed in front of the camera 780. In front of the camera there is a large field of view optic 782, having a field of view of up to 90° depending on the VKB geometry used, this optic being common to both of these two modes. Selecting between these modes is done by a mode selection slider 786 that contains an IR cut-on window filter 788 and a field shrinking lens with a built-in IR cut-off filter 780.

In the VC mode, the mode selection slider 786 positions a field shrinking lens with an IR-cut-off filter that narrows the effective camera field of view to about 30°. This field of view should preferably have a distortion level of less than 4% and an MTF of less than approximately 60% at 30 cy/mm in the visible.

In the VKB mode, the mode selection slider 786 positions an IR cut-on filter window 788 in front of the field lens 782. It is sufficient for this field of view to have a high level of distortion of up to 25%, and a low MTF, typically less than 20% at 20 cy/mm at 785 nm.

Reference is now made to FIG. 12F, which is an embodiment providing four fields of view using a fixed low-resolution camera, and a high-resolution camera incorporating a swiveled mirror similar to that shown in the embodiment of FIG. 12B. Preferred optical arrangements for these four fields of view are now described.

The VKB field of view 790 mode may preferably be imaged on a low-resolution camera (CIF) 792 with a lens 794 having a large field of view, of up to 90°, depending on the geometry used. A filter, preferably an interference filter 816, such as is shown in FIG. 10A or 10B, preferably comprising a visible transmissive filter together with a filter for transmitting the 780 nm IR illumination, either as a specific bandpass filter, or as a Lowpass filter, is preferably disposed in front of the camera 792. In front of the lens 794 there is a fixed IR cut-on filter window 796. This large field of view imaging system can have a level of distortion of up to approximately 25%, and a low MTF, typically of less than 20% at 20 cy/mm at 785 nm is sufficient.

A top swivel head 800 comprises a tilted mirror 802 mounted on a rotating base 804, shown in FIG. 12B schematically by the circular arrow above the swivel head. Mirror 802 may be fixed in a predetermined tilted position or alternatively may be pivotably mounted. Selectably disabling of the passage of light through the swivel head 800 may be achieved, for example when a fixed tilted mirror is employed, by rotating the head to a dummy position at which no light can enter. Alternatively, when a pivotably mounted tilted mirror is employed, the mirror may be pivoted to a position at which no light can enter.

Although the swivel head can rotate 804 and capture an image in any direction, however it is believed to be more useful to define discrete imaging stations. Movement between stations may require the rotation of the image on the screen. The image obtained is a mirror image, which can be corrected electronically if needed. An IR cut-off filter 806 is positioned just under the swivel head 800 to enable a true color picture to be captured.

The light from the swivel head 800 passes via a focussing lens 808 with a field of view of the order of 30° or less to the CMOS camera 810. Additional optics (not shown in FIG. 12F) may be provided facing each station of the swivel head to enable a given field of view to be suitably imaged.

A VSSR mode is obtained by enabling the top swivel head 800 for VSSR imaging and rotating it to the VSSR station position that is at the rear part of the handset, such that the VSSR field of view 812 is imaged.

A VC mode is obtained by enabling the top swivel head 800 for VC imaging, and rotating it to the VC station position at the front side of the handset, where the LCD is located, such that the VC field of view 814 is imaged. Using this option, only part of the COMS imaging plane is utilized, this being known as the windowing option. Otherwise, the image is down sampled to give the lower resolution VC image, this being known as the down sampling option.

A CUP mode could be realized by one of the methods described above in relation to the embodiment of FIG. 12A.

Reference is now made to FIG. 12G, which is an embodiment providing four fields of view using a camera on a horizontal swivel with docking stations. In this embodiment, the camera 820, together with its focussing optics 822 and filter 824, whose function will be described below, and is swiveled about a horizontal axis 826, which is aligned in a direction out of the plane of the drawing of FIG. 12G. The four fields are obtained by positioning the camera in fixed stations. At each station, additional optics can optionally be positioned to enable the intended function at that station. Swiveled cameras in a cell-phone have been described in the prior art.

The common optics generally comprises a high-resolution CMOS camera 820, either VGA or 1.3M pixel, and a 20°-30° field of view lens 822. A filter, not shown in FIG. 12G, but similar to that used in the embodiments of FIG. 10A or 10B, preferably comprising a visible transmissive filter together with a filter for transmitting the 780 nm IR illumination, either as a specific bandpass filter, or as a Lowpass filter, is preferably disposed in front of the camera 840, or as part of the camera entrance window. Preferred optical arrangements for these four fields of view are now described.

In the VSSR mode, the camera is stationed in front of an IR cut-off filter window 824 at the rear side of the handset, facing the entrance aperture from the VSSR field of view 828. The optics for this field should have a low distortion, preferably of <2.5%, and should support a camera resolution having an MTF of ˜50% at 50 cy/mm for the VGA camera, and 60% at 70 cy/min for a 1.3M camera.

In the VC mode, the camera, now shown in position 830, is stationed in front of an IR cut-off filter window 832 at the front side of the handset, facing the entrance aperture from the VC field of view 834. At this position the image is down-sampled. The optical resolution is preferably better than approximately 60% at 35 cy/mm for visible light, and the distortion should be less than 4%.

In the CUP mode, the camera, shown in position 840, is pointed upwards towards a macro lens assembly 842 with an IR cut-off filter 844. The optics for this field should have a low distortion, preferably of less than <2.5%, and should support the camera resolution, preferably having an MTF of at least 50% at 50 cy/mm for the VGA camera and at least 60% at 70 cy/mm for a 1.3M camera.

Finally, in the VKB mode, the camera, shown in position 846, is stationed pointing downwards towards the location of the keyboard projection. In this station, the optics in front of the lens preferably includes an expander lens 848 and an IR cut-on filter window 850. In this mode the camera is typically operated in a windowed, down sampled mode. The field of view 852 of the overall optics is wide, typically up to 90°, depending on the geometry used. This large field of view can tolerate a high level of distortion, typically of up to 25%, and need have only a low MTF, typically less than 20% at 20 cy/mm at 785 nm.

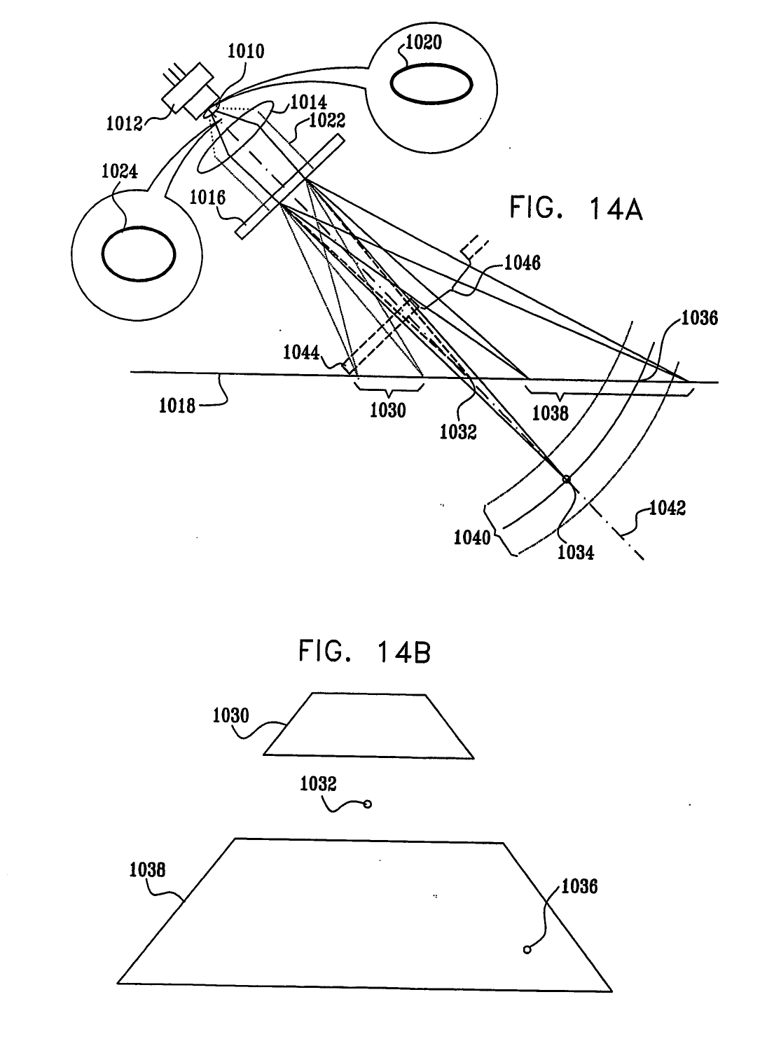

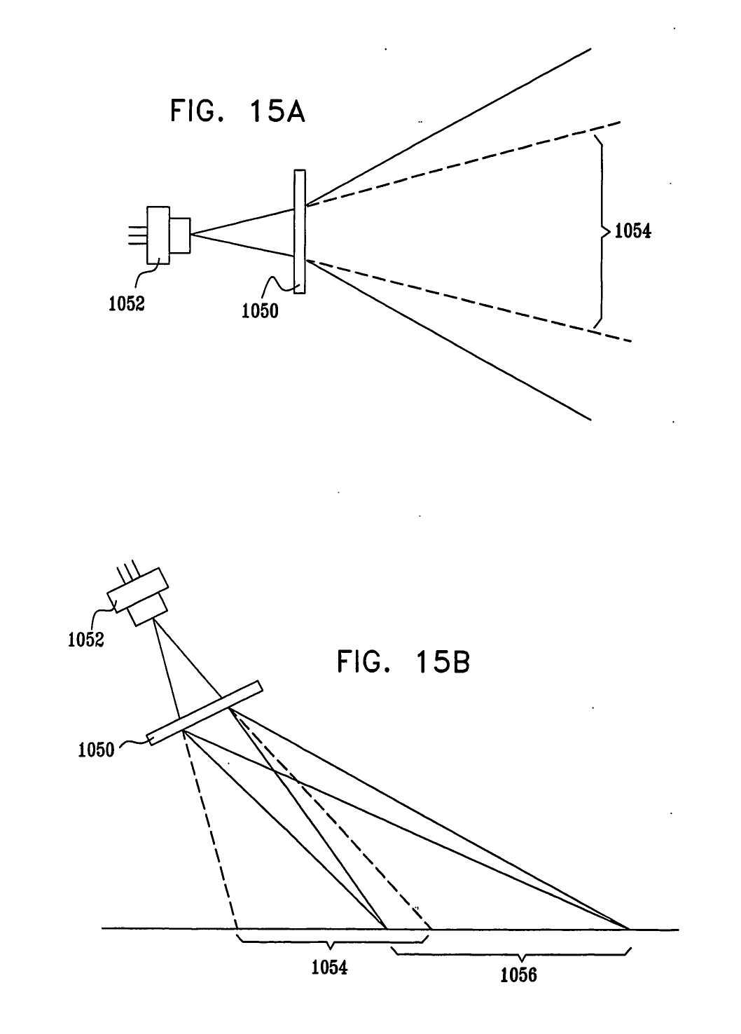

Reference is now made to FIG. 13 which is simplified schematic illustration of optical apparatus useful for projecting templates, constructed and operative in accordance with a preferred embodiment of the present invention. FIG. 13 illustrates projecting an image template using a diffractive optical element (DOE) 1000 in a virtual interface application. The astigmatism that arises in prior art arrangements when DOE illumination is provided by impinging a focused beam on the DOE, is eliminated in this preferred embodiment of the present invention, by directing a beam from a light source 1002, such as a laser diode through a collimating lens 1004, thus focusing it to an infinite conjugate distance, so that all the rays are parallel to a collimation axis 1010, and impinge on the DOE 1000 at the same angle. A low powered focusing lens 1006 is employed to focus the diffracted spots onto the image field as best as possible at the optimal spot for focusing, which is somewhere in the middle of the field, as explained below in connection with FIGS. 14A and 14B.

As shown in the calculated, diffractive ray tracing illustrations in FIG. 13, as seen in the insert 1008, a significant improvement in reduction of astigmatism, and thus of focal spot size, is attainable in this configuration, as compared with DOE imaging systems where a non-collimated beam is incident on the DOE. This improved result can provide brighter diffracted spots and thus a higher contrast image with less projected power. Focusing lens 1006 can be designed so that the radii of curvature of the surfaces thereof are centred on the emitting region of the DOE, to minimize additional geometrical aberrations. This lens can also be designed with aspheric surfaces to obtain variable focal lengths corresponding to different diffraction angles corresponding to different regions of the projected image.

Reference is now made to FIGS. 14A and 14B. FIG. 14A is a simplified schematic illustrations of an implementation of the apparatus of FIG. 13 in accordance with a preferred embodiment of the present invention, while FIG. 14B is a schematic view of the image produced in the image plane by the apparatus of FIG. 14A. One of the factors that reduces the quality of such projected images of the type discussed hereinabove with reference to FIG. 13, arises from the limited depth of field of the collimating and/or focusing lens or lenses, coupled with the oblique projection angle, which makes it difficult to obtain a high quality focus over an entire image field.

From geometrical optics considerations it is known that the depth of field of a focussed spot varies inversely with the focussing power used. Thus, it is clear that, for a given DOE focussing power, the larger the illuminating spot on the DOE, the smaller the depth of field will be. Therefore, to maintain a good depth of focus at the image plane, it is advantageous to use a collimating lens with a focal length sufficiently short such that a minimum area of the DOE is illuminated, commensurate with illuminating sufficient area in order to obtain a satisfactory diffracted image.

A typical laser diode source, as used in prior art DOE imaging systems, generally produces an astigmatic beam with an elliptical shape 1020, as shown in an insert in FIG. 14A. This results in illumination of the DOE with a spot that is elongated along one axis, corresponding to the slow axis 1022 of the laser diode, and a corresponding reduction in the depth of field of the projected image after the DOE. In contrast, in accordance with a preferred embodiment of the present invention, a beam-modifying element 1010 is inserted between a laser diode 1012 and a collimating/focusing element 1014 to generate a generally more circular emitted beam 1024, as shown in the second insert of FIG. 14A, and this beam is directed along an axis 1042. The collimating/focusing element 1014 can thus be chosen to illuminate a sufficient area of a DOE 1016 with a minimal overall spot dimension, resulting in the maximum possible depth of field 1040 for a given DOE focal power. A low powered focusing lens can be incorporated beyond the DOE, as shown in the embodiment of FIG. 13, in order to provide more flexibility in the optical design for focusing the diffracted spots onto the image field.

FIG. 14B illustrates schematically the image obtained across the image plane 1018, using the preferred projection system shown in FIG. 14A. FIG. 14B should be viewed in conjunction with FIG. 14A. The optimal focal point 1036 is designed to minimize the defocus and geometrical distortions and aberrations across the entire image. A beam stop 1044 is preferably provided to block unwanted ghost images or hot spots arising from zero order and other diffraction orders. Furthermore, there is no need for a window 1046 to define the desired projected beam limits.

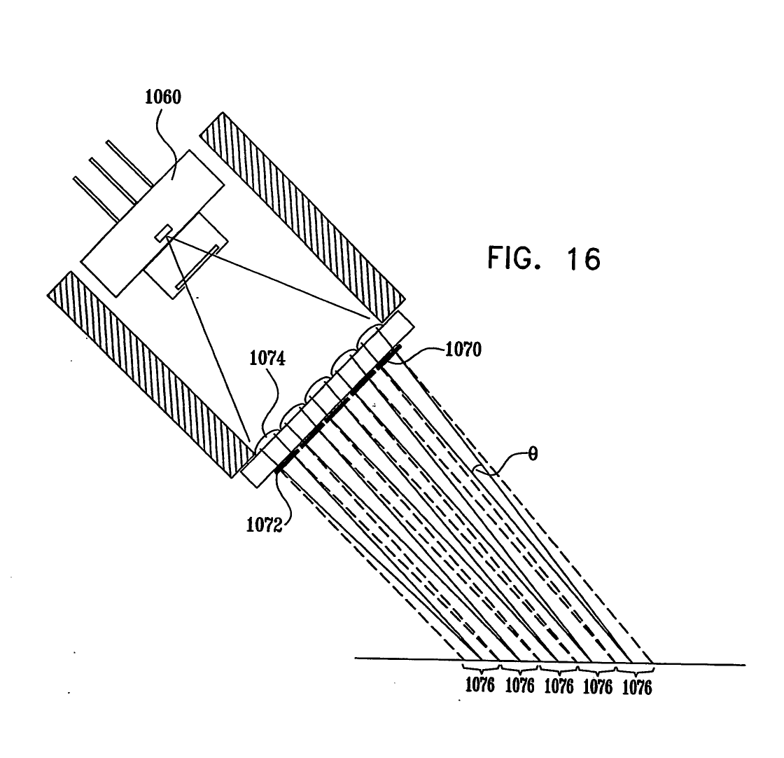

Reference is now made to FIGS. 15A and 15B, which are respective simplified top view and side view schematic illustrations of apparatus useful for projecting templates, constructed and operative in accordance with another preferred embodiment of the present invention. As seen in FIGS. 15A and 15B, this embodiment differs from prior art systems in that a non-periodic DOE 1050 is used, which generally needs to be precisely positioned in front of a laser source 1052, and does not require a collimated illuminating beam. Each impinging part of the illuminating beam generates a separate part of an image template 1056.

One of the advantages of this configuration is that no focusing lens is required, potentially reducing the manufacturing cost. Another advantage is that there is no bright zero order spot from undiffracted light, but rather a diffuse zero order region 1054 whose size is dependent on the laser divergence angle. This type of zero order hot spot does not present a safety hazard. Furthermore, if it does not impact negatively on the apparent image contrast, because of its low intensity and diffusiveness, it does not have to be separated from the main image 1056 and blocked, as was required in the embodiment of FIGS. 14A and 14B, thereby reducing the minimum required window size.

Reference is now made to FIG. 16, which is a simplified side view schematic illustration of apparatus useful for projecting templates, constructed and operative in accordance with yet another preferred embodiment of the present invention. FIG. 16 schematically shows a cross section of an improved DOE geometry. A laser diode 1060 is preferably used to illuminate a DOE 1072. However, unlike prior art illumination schemes, the DOE 1072 is divided such that different sections 1070 are used to project different regions 1076 of the virtual interface template. Each section 1070 of the DOE 1072 thus acts as an independent DOE designed to contain less information than the complete DOE 1072 and have a significantly smaller opening angle θ. This reduces the period of the DOE 1072 and consequently increases the minimum feature size, greatly simplifying fabrication. This design has the added advantage that the zero order and ghost images of each segment can be minimized to the extent that they do not need to be separated and masked as in the prior art. Thus the DOE can serve as the actual device window allowing for a much more compact device.

All the separate sections 1070 are preferably calculated together and mastered in a single pass, so that they are all precisely aligned. Each DOE section 1070 can be provided with its own illumination beam by forming a beam splitting structure such as a microlens array 1074 on the back side of the substrate of the DOE 1072. Alternative beam splitting and focusing techniques can also be employed.

The size of the beam splitting and focusing regions can be adjusted to collect the appropriate amount of light for each diffractive region of the DOE to insure uniform illumination over the entire field.

This technique also has the added advantage that the focal length of each segment 1070 can be adjusted individually, thus achieving a much more uniform focus over the entire field even at strongly oblique projection angles. Since this geometry has low opening angles θ for each of the diffractive segments 1070, and a correspondingly larger minimum feature size, the design can use an on-axis geometry, since the zero order and ghost image can be effectively rejected using standard fabrication techniques. Thus no masking is required.

One drawback of this geometry is the fact that the entire element acts as a non-periodic DOE requiring precise alignment with the optical source. The divergence angle and energy distribution of the diode laser source, as well as the distance to the optical element, must also be accurately controlled in order to illuminate each DOE section and its corresponding region of the projected interface with the appropriate amount of energy.

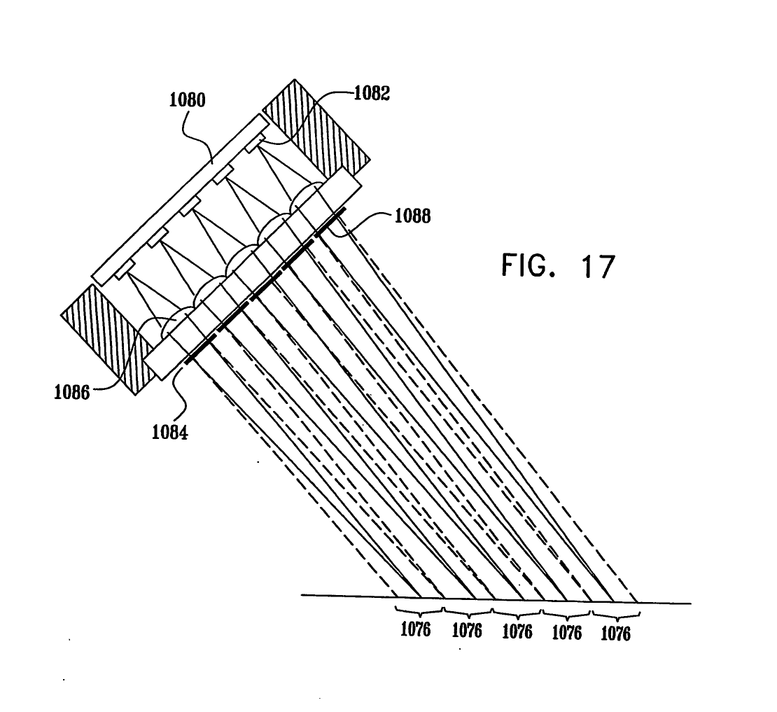

Reference is now made to FIG. 17, which is a simplified side view schematic illustration of apparatus useful for projecting templates constructed and operative in accordance with still another preferred embodiment of the present invention. Here, rather than using a single, relatively high powered diode laser as the light source for the segmented DOE, as is done in the preferred embodiment shown in FIG. 16, a two dimensional array 1080 of low powered, vertical cavity surface emitting lasers (VCSELs) 1082 is placed behind a segmented DOE 1084 and segmented collimating/focusing elements 1086. The number and period of the VCSELs 1082 in array 1080 can be precisely matched to the DOE segments so that each one will illuminate a single DOE segment 1088.

The array 1080 still needs to be positioned accurately behind the element in order not to result in a distorted projected image, but there is no need to control the divergence angle of the individual emissions other than to make sure that all the light from each emitting point enters its appropriate collimating/focusing element 1086 and sufficiently fills the aperture of the corresponding DOE segment 1088 to obtain good diffraction results.

This structure of FIG. 17 is very compact since there is no need to allow the light to propagate until it covers the entire DOE 1084. There is also no laser light potentially wasted between the collimating segments of the DOE element as in the design shown in the embodiment of FIG. 16. The design of the collimating/focusing elements is also simplified since each laser source is centred on the optical axis of its individual lens 1086. This design can also be very compact since there is no need to separate the DOE from the laser sources far enough to fill an aperture of several mm as in the embodiment of FIG. 16. Since there is also no need to mask unwanted diffraction orders, the entire projection module can be reduced to a flat element with a thickness of several millimeters.

Reference is now made to FIG. 18, which is a simplified schematic illustration of a laser diode package incorporating at least some of the elements shown in FIGS. 13-15B, for use in a DOE-based virtual interface projection system. Here all the optical elements and mechanical mountings are miniaturized and contained in a single optical package 1100 such as an extended diode laser can. A diode laser chip 1102, mounted on a heat sink 1104, is located inside the package 1100. A beam modifying optical element 1106 is optionally placed in front of the emitting point 1112 of the diode laser chip 1102, to narrow the divergence angle of the astigmatic laser emission and provide a generally circular beam. A collimating or focusing lens 1108 is optionally inserted into the package 1100 to focus the beam where required.

Optical elements 1106 and 1108 need to be precisely positioned in front of the laser beam by means of an active alignment procedure to precisely align the direction of the emitted beam. A diffractive optical element DOE 1110 containing the image template is inserted at the end of the package, aligned and fixed in place. This element can also serve as the package window, with the DOE 1110 being either on the inside or the outside of the window 1114. If a non-periodic DOE is employed, the beam modifying optics and/or the collimating optics can be selectively dispensed with, resulting in a smaller and cheaper package.

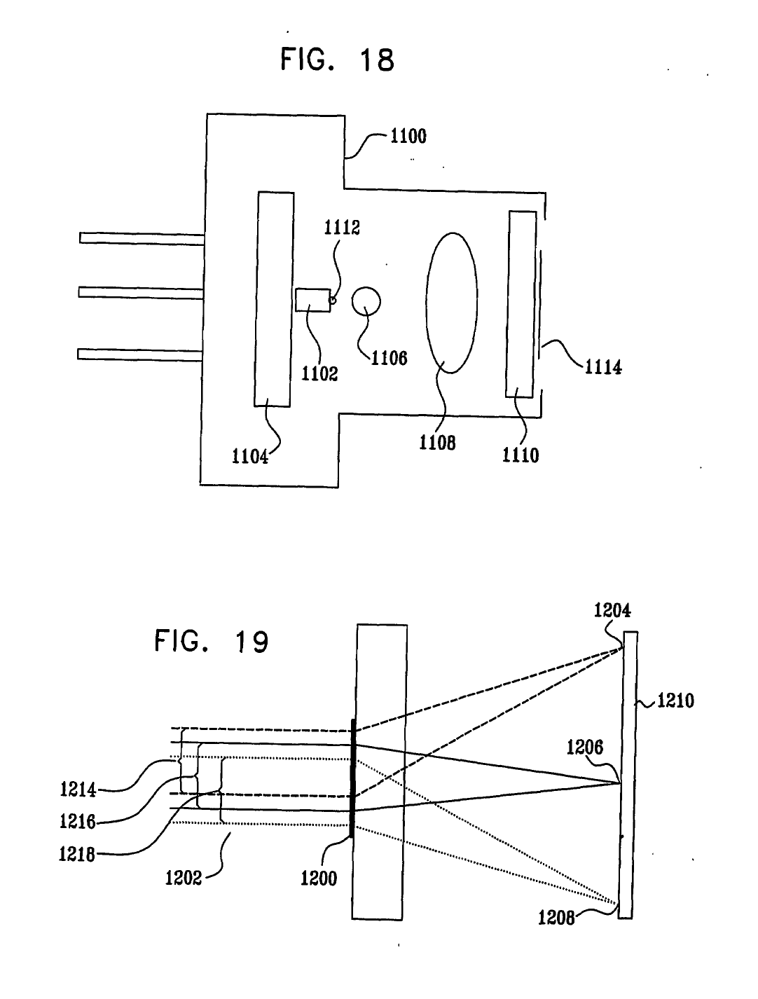

Reference is now made to FIG. 19, which is a simplified schematic illustration of diffractive optical apparatus, constructed and operative in accordance with another preferred embodiment of the present invention, useful for scanning, inter alia, in apparatus for projecting templates, such as that described in the previously mentioned embodiments of the present invention. This apparatus provides one dimensional or two dimensional scanning in an on-axis system, without the need for any reflections or turning mirrors. Such a system can be smaller, cheaper and easier to assemble than mirror based scanners.

FIG. 19 illustrates the basic concept. A non-periodic DOE 1200 is designed so that the angle of diffraction is a function of the lateral position of illumination incidence on the DOE. In this preferred example, as a collimated beam 1202 in translated across the surface of the DOE 1200, to different positions 1214, 1216 and 1218, it is diffracted and focused to discrete points 1204, 1206, 1208, at different focal imaged positions. The non-periodic DOE can preferably be constructed such that as the mutual position of the beam and the DOE are varied, the angle of diffraction can be made to vary according to a predetermined function of the relative position of the input beam and DOE. Thus, for example, a DOE oscillated in a sinusoidal manner in front of the impinging beam, when constructed according to this preferred embodiment, can be made to provide a linear translation of the focussed spot on the image screen 1210. Furthermore, DOE can also be constructed so that the intensity can also be linearized across the scan. This is a particularly useful feature for optical scanning applications.

Even though there may be significant overlap between the various incidence positions of the beam, the DOE is constructed in a non-periodic fashion to diffract all the light to a point whose position is determined by the total incident area of illumination on the DOE. The focal position can also be varied as a function of the diffraction angle to keep the spot in sharp focus across a planar field. The focusing can be also done by a separate diffractive or refractive element, not shown in FIG. 19, downstream of the DOE 1200, or the incident beam itself can be collimated to a point at the focal plane of the device.

A second element with a similar functionality may be provided along an orthogonal axis and positioned behind the first DOE to diffract the emitted spot along the orthogonal axis, thus enabling two dimensional scanning.

Rather than actually scanning the input beam, which would mean vibrating the laser diode sources, the input beam can be held stationary, and DOE elements can preferably be oscillated back and forth to generate a scanned beam pattern. Scanning the first element at a higher frequency and the second element at a lower frequency can generate a two dimensional raster scan, while synchronizing and modulating the laser intensity with the scanning pattern generates a complete two dimensional projected image.

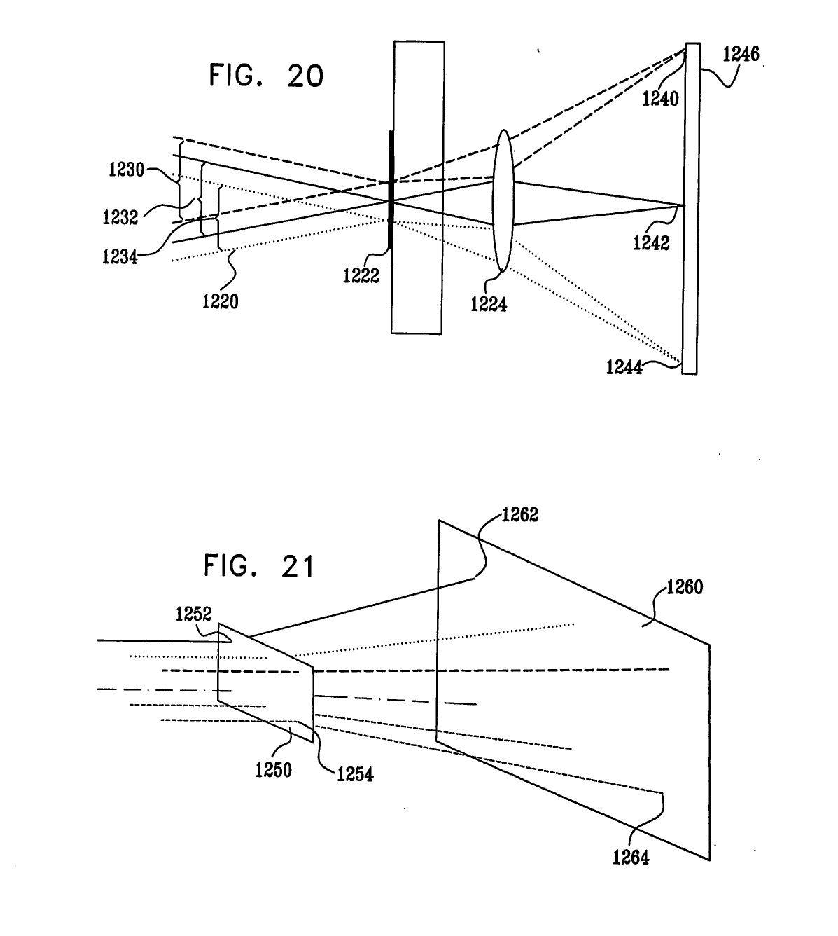

Reference is now made to FIG. 20, which is a simplified schematic illustration of diffractive optical apparatus, constructed and operative in accordance with another preferred embodiment of the present invention, useful for scanning, inter alia, in apparatus for projecting templates, such as that described in the previously mentioned embodiments of the present invention. In the embodiment of FIG. 20 the incident laser beam 1220 is focused to a relatively small spot at the DOE 1222, so that there is little or no overlap between the input regions for different diffraction angles. This allows for greater changes in the steering angle for smaller translational movements. A secondary focus lens 1224 is then inserted to refocus the diffracted beams onto the image plane 1246. Different effective input beam positions 1230, 1232, 1234, result in different focussed spots 1240, 1242, 1242.

These functionalities can be further combined into a single DOE where the horizontal position determines the horizontal angle of diffraction and the vertical position determines the vertical angle of diffraction. This is illustrated schematically in FIG. 21, which is a simplified illustration of the use of such a DOE for two-dimensional scanning. Here, the DOE 1250 is designed so that when it is translated in two directions perpendicular to the direction of the light propagation, the beam is deflected in two dimensions. For example, when the beam is incident on the top left section 1252 of the DOE, it is deflected upwards and to the left, being focussed on the image plane 1260 at point 1262. Similarly, when the beam is incident on the bottom right corner 1254 of the DOE, it is deflected downwards and to the right, being focussed on the image plane 1260 at point 1264. This element has the functionality of the DOE of FIG. 19 combined with an optional second element for providing scanning in the orthogonal direction. As described previously, it is to be understood that rather than scanning the input beam, the input beam is held stationary, and the DOE element is preferably oscillated in two dimensions to generate a scanned beam pattern.

Orthogonal X and Y scanning can be integrated into a single element as is illustrated in FIG. 22, which is a simplified illustration of a device for performing two-dimensional displacement of a DOE useful in the embodiment of FIG. 21. A two dimensional, non-periodic DOE 1270 as described in FIG. 21 can be placed on a low mass support 1272 having a high resonant oscillation frequency in the horizontal direction of the drawing. This central section is attached to an oscillation frame 1274 that sits within a second, fixed frame 1276. The larger mass of the internal 1274 frame in combination with the central section provide a significantly lower resonant frequency than that of the low mass support for the DOE 1270.

By driving the entire device with one or more piezoelectric elements 1278 with a drive signal containing both resonant frequencies, a two axis, resonant raster scan can be generated. By tuning the mass of the DOE and support 1272 and the internal oscillation frame 1274, along with the stiffness of the lateral motion oscillation supports 1280 and the vertical motion oscillation supports 1282, it is possible to tune the X and Y scanning frequencies accordingly. This design can provide a compact, on-axis two dimensional scanning element.

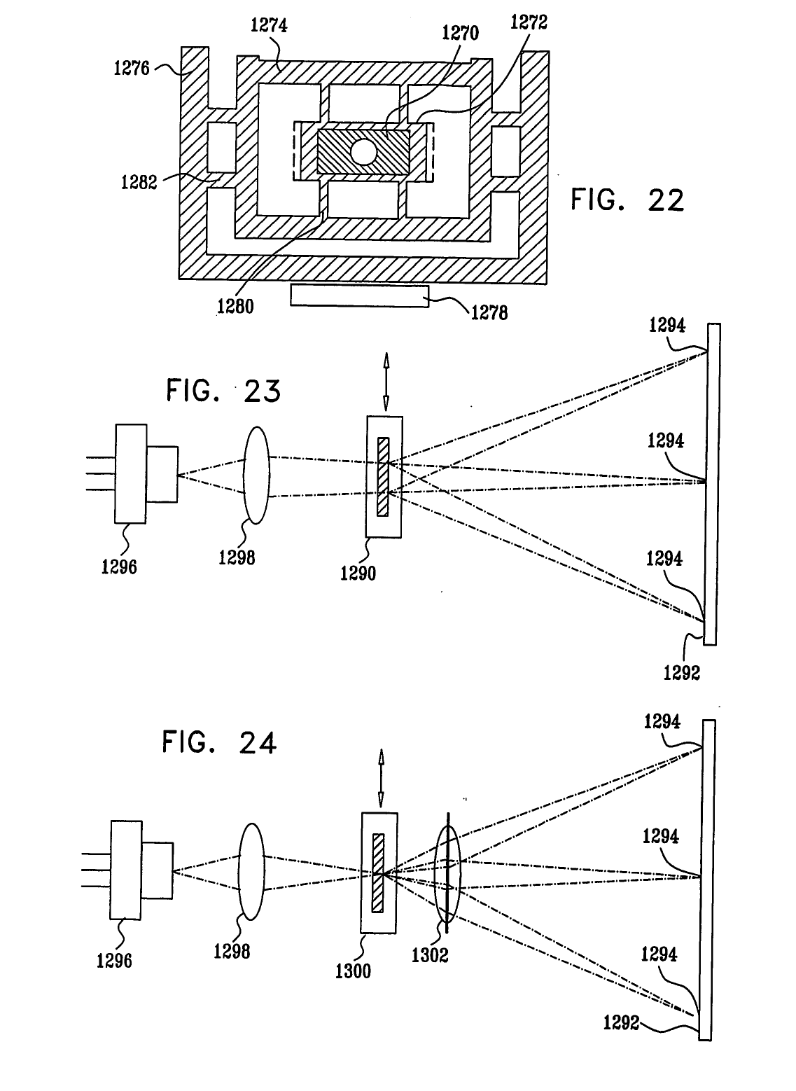

Reference is now made to FIG. 23, which is a simplified schematic illustration of diffractive optical apparatus useful in scanning applications, inter alia, in apparatus for projecting templates, constructed and operative in accordance with a preferred embodiment of the present invention. A one dimensional scanning DOE element 1290, such as that described in the preferred embodiment of FIG. 19, is oscillated in one direction to scan a spot across an image plane 1292, to different focus positions 1294. The DOE is preferably illuminated by a laser diode 1296, and a collimating lens 1298.

Reference is now made to FIG. 24, which is a simplified schematic illustration of diffractive optical apparatus useful in scanning applications, inter alia, in apparatus for projecting templates, constructed and operative in accordance with another preferred embodiment of the present invention. A one dimensional scanning DOE element 1300, such as that described in the preferred embodiment of FIG. 20, is oscillated in one direction to scan a spot across an image plane 1292, to different focus positions 1294. The DOE 1300 is preferably illuminated by a laser diode 1296, and a collimating lens 1298, and additional focussing after the DOE is provided by an auxiliary lens 1302.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1-70. (canceled)

71. An electronic camera comprising:
an electronic imaging sensor providing outputs representing imaged fields;
a first imaging functionality employing said electronic imaging sensor for data entry responsive to user hand activity in a first imaged field;
at least a second imaging functionality employing said electronic imaging sensor for taking at least a second picture of a scene in a second imaged field;
optics associating said first and said at least second imaging functionalities with said electronic imaging sensor; and
a user-operated imaging functionality selection switch operative to enable a user to select operation in one of said first and said at least second imaging functionalities.

72. An electronic camera according to claim 71, and also comprising a projector, projecting a data entry template.

73. An electronic camera according to claim 71, and wherein said optics associating said first and said at least second imaging functionalities with said electronic imaging sensor includes at least one optical element which is selectably positionable upstream of said sensor only for use of said at least second imaging functionality.

74. An electronic camera according to claim 71 and wherein said optics associating said first and said at least second imaging functionalities with said electronic imaging sensor does not include an optical element having optical power upstream of said sensor for use of said first imaging functionality.

75. An electronic camera according to claim 71 and wherein said optics associating said first and second imaging functionalities with said electronic imaging sensor includes a wavelength dependent splitter which defines separate optical paths for said first and said second imaging functionalities.

76. An electronic camera according to claim 71 and wherein said user operated imaging functionality selection switch is operative to select operation in one of said first and said at least second imaging functionalities by suitable positioning of at least one shutter to block at least one of said imaging functionalities.

77. An electronic camera according to claim 71 and wherein said first and said at least one second imaging functionalities define separate optical paths.

78. An electronic camera according to claim 77 and wherein said separate optical paths extend in different directions.

79. An electronic camera according to claim 77 and wherein said separate optical paths extend in different directions.

80. An electronic camera according to claim 78 and wherein said separate optical paths have different fields of view.

81. An electronic camera according to claim 79 and wherein said separate optical paths have different fields of view.

82. An electronic camera according to claim 75 and wherein said wavelength dependent splitter separates visible and IR spectra for use by said first and second imaging functionalities respectively.

83. An electronic camera according to claim 71 and also comprising a liquid crystal display on which said outputs representing imaged fields are displayed.

84. An electronic camera according to claim 71 and wherein said optics associating said first imaging functionality with said electronic imaging sensor comprises a field expander lens.

85. An electronic camera comprising:
an electronic imaging sensor providing outputs representing imaged fields;
a first imaging functionality employing said electronic imaging sensor for taking a picture of a scene in a first imaged field;
at least a second imaging functionality employing said electronic imaging sensor for taking a picture of a scene in at least a second imaged field;
optics associating said first and said at least second imaging functionalities with said electronic imaging sensor; and
a user-operated imaging functionality selection switch operative to enable a user to select operation in one of said first and said at least second imaging functionalities.

86. An electronic camera according to claim 71 and wherein said optics associating said first and said at least second imaging functionalities with said electronic imaging sensor is fixed.

87. An electronic camera according to claim 71 and wherein said optics cause said first and said second imaged fields each to undergo a single reflection before being imaged on said electronic imaging sensor.

88. An electronic camera according to claim 71 and wherein said optics cause said first imaged field to be imaged directly on said electronic imaging sensor, and said second imaged field to undergo two reflections before being imaged on said electronic imaging sensor.

89. An electronic camera according to claim 71 and wherein said optics cause said second imaged field to be imaged directly on said electronic imaging sensor, and said first imaged field to undergo two reflections before being imaged on said electronic imaging sensor.

90. An electronic camera according to claim 88 and wherein the second of said two reflections is effected by a pivoted stowable mirror forming part of said optics.

91. An electronic camera according to claim 87 and wherein said reflection of said second imaged field is effected by a pivoted stowable mirror forming part of said optics.

92. An electronic camera according to claim 71 and wherein said first imaging functionality employs a spectral band in the infra red region, and said second imaging functionality employs a spectral band in the visible region.

93. An electronic camera according to claim 82 and also comprising:
a first filter set employing said first imaging functionality and comprising at least one filter transmissive in said visible region and in said spectral band in the infra red region, and at least one filter transmissive in said infra red region to below said spectral band in the infra red region and not transmissive in the visible region; and
a second filter set employing said second imaging functionality and comprising at least one filter transmissive in the visible region up to below said spectral band in the infrared region.

94. An electronic camera according to claim 83 and wherein said first and said second imaging functionalities are directed along a common optical path, said first and said second filter sets are interchanged in accordance with the imaging functionality selected by said selection switch.

95. An electronic camera according to claim 71, and wherein said user-operated imaging functionality selection switch operates by rotating said electronic imaging sensor in front of said optics associating said first and said at least second imaging functionalities with said electronic imaging sensor.

96. An electronic camera according to claim 71, and wherein said user-operated imaging functionality selection switch operates by rotating a mirror in front of said electronic imaging sensor in order to selectively associate said first and said at least second imaging functionalities with said electronic imaging sensor.

97. An electronic camera according to claim 71, and also comprising a full reflector and partially transmitting beam splitter operative to combine said first and said second imaging fields, and wherein both of said first and said second imaging fields are reflected once by said partially transmitting beam splitter, and one of said first and said second imaging fields is also transmitted after reflection from said full reflector through said partially transmitting beam splitter.

98. An electronic camera according to claim 97 and wherein said partially transmitting beam splitter is dichroic.

99. An electronic camera according to claim 97 and wherein said full reflector also has optical power.

100. An electronic camera according to claim 71 and also compromising telephone functionality.

101. An electronic camera according to claim 71 and also compromising at least one personal digital assistant functionality.

102. An electronic camera according to claim 71 and also compromising remote control functionality.
